(19) United States
(12) Patent Application Publication
(10) Pub. No.: US 2025/0258892 A1
(43) Pub. Date: Aug. 14, 2025

(54) GENERATIVE ARTIFICIAL INTELLIGENCE CONTENT MANAGEMENT

(71) Applicant: DRSK AI Corp., Seattle, WA (US)

(72) Inventors: Sarah Baily, Hillsboro, OR (US); Roberto Rodriguez-Lawson, Santa Fe, NM (US); Guillermo Zuniga Brambila, Bellevue, WA (US)

(21) Appl. No.: 19/048,782

(22) Filed: Feb. 7, 2025

Related U.S. Application Data
(60) Provisional application No. 63/551,275, filed on Feb. 8, 2024.
(60) Provisional application No. 63/678,463, filed on Aug. 1, 2024.

(51) Int. Cl. G06F 21/10; G06F 16/14; G06F 16/435

(52) U.S. Cl. CPC G06F 21/107; G06F 16/152; G06F 16/435

(57) ABSTRACT

This disclosure relates to approaches for managing generative artificial intelligence content. Some aspects relate to managing and enforcing licensing conditions for various actors in generative artificial intelligence, such as content creators, model owners, and platform providers. Some aspects relate to lineage tracing, in which an asset is analyzed to determine what other assets it was based on and/or to determine which other assets were generated based on a given asset. Lineage tracing can be based on one or more of metadata analysis, hash analysis (such as perception hash analysis), or vector similarity. In some implementations, a vector embedding model is used to generate vector embeddings of assets, and the vector embeddings are compared to identify similar assets.

### CROSS-REFERENCE TO RELATED APPLICATIONS

This application claims priority to, and the benefit of, U.S. provisional patent application Ser. No. 63/551,275 filed on Feb. 8, 2024, incorporated herein by reference in its entirety, this application claims priority to, and the benefit of, U.S. provisional patent application Ser. No. 63/678,463 filed on Aug. 1, 2024, incorporated herein by reference in its entirety.

### TECHNICAL FIELD

This application is directed to a platform for generative artificial intelligence media and/or digital assets (generally, assets). In particular, some implementations relate to, the platform can be used for generating assets, tracing the lineage of generated assets, and/or generating embeddings for generated assets.

### BACKGROUND

The approaches described in this section are approaches that could be pursued, but not necessarily approaches that have been previously conceived or pursued. Thus, unless otherwise indicated, it should not be assumed that any of the material described in this section qualifies as prior art merely by virtue of its inclusion in this section.

Generative artificial intelligence presents a significant opportunity for creators to generate and/or modify media and/or digital assets (referred to generally herein as assets or digital assets). However, there are significant problems with current approaches, which can raise questions as to the legal status of generated assets. For example, generative AI models can be trained on unlicensed content, which can raise concerns/questions about whether or not media and/or digital assets generated by such models potentially violate the intellectual property rights of others. Accordingly, there is a need for improved approaches to the use of generative AI.

Intellectual property rightsholders may want to stop others from the unauthorized use of their material. However, identifying unauthorized use can be difficult and is often reactive. Current technology is inadequate, often leaving rightsholders with no reliable, accurate way to detect violations of their intellectual property rights.

In some cases, intellectual property rightsholders may be interested in licensing their content for use in creating new content using generative AI. However, rightsholders may not have a simple of reliable way to offer licensing, enforce licensing terms, detecting infringement, track usage, and so forth. Additionally, end users of generative AI solutions may want to take measures to reduce the risk that the content they generate could be subject to copyright or other legal claims, but current technology falls far short of meeting this need.

Accordingly, there is a need for improved approaches to detecting infringement of intellectual property in generated assets, for licensing IP assets, for tracking the use of IP assets used in generative AI applications, and so forth.

### BRIEF DESCRIPTION OF THE DRAWINGS

Features, aspects, and advantages of the present disclosure are described with reference to drawings of certain implementations, which are intended to illustrate, but not to limit, the present disclosure. It is to be understood that the attached drawings are for the purpose of illustrating concepts disclosed in the present disclosure and may not be to scale.

FIG. 1 is a diagram that illustrates various components of a system for carrying out the methods described herein according to some implementations.

FIG. 2 is a block diagram that illustrates the relationships between different platform users and different aspects of the platform.

FIG. 3 illustrates IP rightsholder onboarding and access processes according to some implementations.

FIG. 4 is a flowchart that illustrates example processes for initial and subsequent access to a platform by a model owner.

FIG. 5 illustrates a high level block diagram of various components of a license system according to some implementations.

FIG. 6 is a flowchart that illustrates an example process for submitting content to a platform according to some implementations.

FIG. 7 is a flowchart that illustrates an example process for training a model on an asset collection according to some implementations.

FIG. 8 illustrates an example process for applying moderation.

FIG. 9 is a block diagram that illustrates an example moderation process according to some implementations.

FIG. 10 is a flowchart that illustrates initial access and subsequent access process flows for service providers according to some implementations.

FIG. 11 is a block diagram that illustrates an example generation system according to some implementations.

FIG. 12 is a flowchart that illustrates an example process for generating content according to some implementations.

FIG. 13 is a block diagram that illustrates an example content generation process according to some implementations.

FIG. 14 is a block diagram that illustrates various components of a verification system according to some implementations.

FIG. 15 illustrates an example process for origin tracking according to some implementations.

FIG. 16 illustrates a high level block diagram of various components of a license system.

FIG. 17 is a block diagram that illustrates an example process for accessing functions for various content types according to some implementations.

FIG. 18 is a block diagram that illustrates an example process for performing processing text/code submissions according to some implementations.

FIG. 19 is a block diagram that illustrates an example process for processing image submissions according to some implementations.

FIG. 20 is a block diagram that illustrates an example process for processing audio submissions according to some implementations.

FIG. 21 is a block diagram that illustrates an example process for processing video submissions according to some implementations.

FIG. 22 is a diagram that illustrates interactions involved in a licensing process according to some implementations.

FIG. 23 is a diagram that illustrates an example licensing flow according to some implementations.

FIG. 24 is a diagram that illustrates an example license renewal process according to some implementations.

FIG. 25 is a block diagram that illustrates various components of a platform and various actors and actions that can utilize the platform according to some implementations.

FIG. 26 is a block diagram depicting an implementation of a computer hardware system configured to run software for implementing one or more of the systems and methods described herein.

### DETAILED DESCRIPTION

Although several implementations, examples, and illustrations are disclosed below, it will be understood by those of ordinary skill in the art that the subject matter described herein extends beyond the specifically disclosed implementations, examples, and illustrations and includes other uses and obvious modifications and equivalents thereof. Implementations are described with reference to accompanying figures, wherein like numerals refer to like elements throughout. The terminology used in the description presented herein is not intended to be interpreted in any limited or restrictive manner simply because it is being used in conjunction with a detailed description of certain specific implementations of the inventions. In addition, implementations can comprise several novel features, and no single feature is solely responsible for its desirable attributes or is essential to practicing the inventions herein described.

Generative Artificial Intelligence (AI) is an emerging market that offers a wealth of possibilities for content creators, intellectual property (IP) rightsholders, and model developers/owners. Using generative AI, end users can easily generate assets such as images, videos, text, 3D models, or other creative content and/or digital assets (referred to generally herein as generated assets). Rightsholders can have a new way to monetize their IP, and model owners/generative platform providers can provide generative AI services in exchange for compensation. However, there can be significant concerns when using generative AI to create generated assets. For example, it can be unclear who, if anyone, has rights in the output of a generative AI model. In some cases, models are trained using copyrighted material, which can raise questions as to potential infringement. For example, a generative AI model could produce an image that could be considered an unauthorized derivative work of someone else's original creation. As another example, a generative AI model could produce output that could give rise to a trademark infringement claim, for example if a generated logo is confusingly similar to a logo of another company.

In some implementations, as described herein, a platform is provided that enables the use of generative models with less legal uncertainty, for example by relying on licensed content when generating new assets. Such a platform can offer many benefits for users, rightsholders, and/or model owners, for example enabling licensing, payment, access to generated assets and/or models, and so forth, as described herein. In some implementations, the platform can provide methods for tracing the origin of generated assets. For example, a rightsholder can search for generated assets that are based on the rightsholder's intellectual property and/or can submit a generated asset to determine the work or works on which it is based.

### Generative Models

Generative models (also referred to as generative artificial intelligence models, generative AI models, generative machine learning models, generative ML models, or simply “models” herein) can be used to generate assets such as audio, images, video, 3D models, written works, and so forth. As used herein, “models” can refer to foundational models, fine-tuned models, low-rank adaptation (LoRA) models, or any other type of model or model component that, alone or in combination with other models, generates assets. In some implementations, generative models can be based on neural networks and can include, for example, generative adversarial networks (GANs), variational autoencoders (VAEs), etc. A GAN can include a generator and a discriminator.

A GAN can be trained by producing random images, with the discriminator differentiating between generated assets and a set of baseline assets (e.g., real images, paintings, drawings, etc.). The discriminator can be used to provide feedback for the generator, such that the generative process is adjusted over time to generate assets that are less distinguishable from the baseline assets. Typically, a generative model is trained on a large dataset, which can result in a model that can generate a wide range of assets.

Convolutional neural networks (CNNs) are commonly used in generative AI tasks because of their ability to capture spatial hierarchies. Networks can learn to identify and manipulate features at different levels of abstraction, which can result in improved generated images or other assets. For example, in a model that uses multiple CNN layers, different layers can identify and manipulate different features at different levels of abstraction. In the case of image analysis or image generation, different levels of abstraction can include, for example, edges, color gradations, and so forth.

In many cases, generative models are trained using large datasets that include assets from many different sources. While such an approach can result in a generative model that can generate new assets having a wide range of styles, subjects, etc., such models can struggle to produce assets that adhere closely to a particular style, that accurately depict particular subjects, and so forth. In some implementations, transfer learning can be used to tune a general purpose generative model for specific tasks. For example, transfer learning can be used to tune a generative model to generate new assets that adhere to a brand standard, a creative studio's artistic style, and so forth.

While specific examples of generative models are discussed, it will be appreciated that the approaches described herein are not specific to any particular type of model. Rather, the approaches herein can be used with generative AI model or generative AI platform.

### Use of Generative Models for Creating Generated Assets

While generative models offer a wide range of possible benefits, there are significant challenges associated with generative AI. For example, generative models can be trained using copyrighted materials. In some cases, a generative AI model developer may not acquire rights to use copyrighted materials for model training, leaving content creators uncompensated and unrecognized. Those who use generative AI models may create content that infringes on the intellectual property rights of others. For example, a generative AI user can intentionally or inadvertently create an unauthorized derivative work of someone else's copyrighted works.

When intellectual property rights are not respected, there can be significant legal and reputational risk. For example, generative AI platforms can be sued for making unauthorized use of copyrighted materials, for contributing to infringement by others, and so forth. Users of generative AI models could be sued by rightsholders for creating unauthorized derivative works, and their reputations can be tarnished if they are perceived as merely exploiting the hard work of others. While much legal risk may fall under copyright law, users of generative AI may also run afoul of trademark law, right of publicity laws, and so forth. For example, an entity may have established trademark rights in characters, logos, and so forth, and the entity may make a trademark claim if its trademarks appear in content generated by others. As another example, a user of generative AI could face a suit under right of publicity laws if they make unauthorized use of an individual's likeness, for example for advertising or selling.

Rightsholders and content creators form the backbone of generative AI, as their works are needed to train generative models to produce new assets. However, in many cases, they may not be adequately compensated or acknowledged. Currently, rightsholders and content creators have limited recourse, as it can be difficult to show that a model was in fact trained using their IP. Even in cases where it is clear that a model has been trained using a rightsholder's content, rightsholders are typically reactive, rather than proactive. That is, the rightsholder may have no way of detecting the unauthorized use of their IP until a generative model is released to the public and can be tested to see if it generates new content that clearly was based on the rightsholder's assets.

Generative AI can raise questions about copyright violations, any rights the copyright holders may have in generated works, and so forth. Many content creators feel that their intellectual property is being used to create unauthorized derivative works or otherwise used in ways they do not want their works to be used. While many rightsholders may be interested in making their works available for use in generative AI, they may want to retain some control over how their IP is used, for example via moderation rules, licensing restrictions, and so forth.

Determining who owns the output generated by a generative model can be a complex issue. For example, the output could be owned by the organization or individual who trained the generative model, by the end user who made use of the generative model, or by a creator or other rightsholder whose work was used to train the generative model. In some cases, multiple rightsholders' assets can be used in creating generative AI content. As IP laws adapt to the new world of generative content creation, it may be the case that generated works are not themselves protected by copyright. In any case, however, it can be important to ensure that rights, whatever they may be, are respected.

AI-generated works can blur the lines between original creation, fair use, unauthorized derivative works, and mere copying. Determining whether or not a generative AI output is sufficiently transformative to escape copyright infringement claims can be challenging.

It can be important for generative model developers and users to establish clear licensing agreements to define the scope and limitations of a generative model's use. For example, a licensing agreement can cover permitted uses, distribution rights, restrictions on content, compensation for model developers/generate platform providers, and compensation for rightsholders whose works were used in training the model, among other considerations. Similarly, those who produce the content used to train models may wish to impose restrictions on how their IP is used, and indeed whether it is used at all, for generative AI. Rightsholders may impose restrictions on use, set fees for use, set expirations for use, and so forth.

As mentioned, it can be difficult to detect IP infringement, either in models or in works generated using generative models, making it difficult to ensure proper attribution, detect copyright infringement, track compliance with licensing terms, and so forth.

Accordingly, there is a need for systems and methods that can be used to license content for use in training generative models and/or generating assets based on copyrighted works. Additionally, there is a need for systems and methods that can detect infringement, duplicates, inaccurate claims of IP ownership, and so forth. Such systems and methods can provide generative model providers and their users alike with confidence that they are complying with applicable IP laws and can ensure that rightsholders whose works are used to train models are fairly compensated. According to some implementations as described herein, it can be advantageous for end users, rightsholders, and/or providers of generative AI services to be able to access a platform via various interfaces, application integrations, and so forth.

In some implementations, a platform can be provided that enables licensing of digital assets (e.g., images, video, audio, text, code, 3D models, etc.), licensing of models, and so forth. In some cases, such a platform can be used to train models for specific tasks, such as to adhere to the look and feel of a particular design house or advertising agency, to comply (e.g., or generally comply or strictly comply) with a company's brand guidelines, and so forth. Some implementations can aid rightsholders in determining where infringement may have occurred, for example by comparing AI-generated assets to a rightsholder's digital assets to determine similarity. According to some implementations described herein, systems and methods can be provided that can be used to detect the usage of copyrighted works in AI-generated content and to compensate rightsholders when their works are used.

### Platform Architecture

In some implementations, a platform is provided that can be used by rightsholders, content creators, end users, and/or model owners/generative platform providers (also referred to herein as service providers) to create content, make media and/or digital assets available, make models available, and so forth. In some implementations, the platform can enable tracking of assets used in the creation of generated assets using generative models. In some implementations, the platform compares a provided generated asset to other digital assets to determine possible copyright infringement. In some implementations, the platform is provided with one or more digital assets and identifies generated assets that potentially infringe on the rights in the provided assets.

In some implementations, a platform includes one or more modules and/or systems. For example, in some implementations, a platform includes a license system, a generation system, and a verification system. In some implementations, the platform includes a management server (e.g., a web server) that can be used to access the platform and to interact with one or more modules of the platform.

In some implementations, the platform provides an onboarding process for rightsholders and/or model owners. In an onboarding process, a rightsholder and/or model owner/generative platform provider can arrange payment terms, set licensing terms, make selections regarding the hosting of assets and/or models, and so forth, as described in more detail herein. In some implementations, an onboarding process includes a verification process. During the verification process, measures can be taken to verify that the rightsholder and/or model owner/generative platform provider is, in fact, the true rightsholder and/or model owner/licensee. The verification process can include using a machine learning model to verify the provided assets, for example to compare the provided assets to other assets, such as assets previously submitted to the platform and/or other assets accessible by the platform, for example by web scraping or using a public API. In some implementations, the verification process can include human review of some or all of the provided assets.

In some implementations, a “white glove” service is provided. Such a service can forego a standard onboarding process and some operations can be skipped, such as verification. The white glove service can be offered to, for example, large, established studios with a significant amount of asset collections or established, major model owners/generative platform providers. While it can be desirable to introduce some friction into an onboarding process to help ensure that incorrect ownership claims are detected, such friction can present a significant obstacle when a large number of assets are involved. Additionally, a standard onboarding process can be difficult to implement for large numbers of assets, as uploading content, embeddings, and so forth can take a significant amount of time and can be prone to errors, for example resulting from network disruptions.

In some implementations, the platform provides various options for model owners and/or rightsholders. For example, in some implementations, a rightsholder can choose to store some or all data on the platform and/or to self-host data. For example, a rightsholder may want to store embeddings on the platform, such as for lineage tracing purposes, but may not want to store original asset collections on the platform, for example to maintain close control over their asset collections. In some cases, a rightsholder may want to host their assets with the platform. For example, a smaller rightsholder may not have the resources or technical knowledge to self-host data in a secure, accessible manner. In some implementations, the platform is configured to determine a payment amount for the rightsholder, for example based on which data is hosted by the platform, how much data is hosted by the platform, and so forth. For example, if a rightsholder chooses to host original asset collections on the platform, there can be significant storage requirements, the cost of which can be passed on to the rightsholder.

In some implementations, the verification system is used during an onboarding process and/or can be used to trace the lineage of generated assets to determine possible infringement or unauthorized use. For example, during an onboarding process, lineage tracking can begin and/or ownership verification can be performed.

In some implementations, the license system is used to define pricing, usage restrictions, and/or other limitations on the use of a rightsholder's assets and/or a model owner's/generative platform provider's models. For example, a rightsholder can upload one or more asset collections, and each asset collection can have associated therewith one or more license terms that define, for example, acceptable uses (e.g., location, time period, type of content, commercial or noncommercial, etc.). In some implementations, the rightsholder defines a default license that can be applied to all of the rightsholder's asset collections. In some implementations, a rightsholder overrides a default license for one or more asset collections. For example, a rightsholder may wish to make asset collections available for commercial use by default but may have one or more assets for which the rightsholder does not wish to permit commercial use, or the rightsholder may not typically impose geographic restrictions on usage but can impose restrictions for some asset collections. In some cases, rightsholders can offer multiple licensing terms for a single asset collection, for example so that use in a particular region or for particular uses costs more or less than other uses, for example so that uses such as personal use, fan art generation, non-profit use, etc., cost less than commercial uses. In some cases, a rightsholder may restrict which models can used to generate new assets using their asset collections and/or charge different rates for using different models. In some implementations, a rightsholder charges a first price for a first type of license and a second price for a second type of license. An end user can select a license based on their intended use of the asset collection.

In some implementations, a model owner uses the license system to impose certain limitations on a model. For example, a model owner or generative platform provider may not want their model or generative platform to be used to generate advertising materials directed at children or may not want their model to be used to generate violent content. In some cases, a model owner or generative platform provider can define multiple licenses for a model/generative platform, and an end user can select a license type based on their intended usage of the model/generative platform.

In some cases, an end user may want to use multiple asset collections when generating content. The different asset collections can have different licensing terms. In some implementations, the platform can be configured to identify one or more models that are permitted by each license. In some implementations, there may not be a model that is permitted by all the asset collections the creator wishes to use, in which case the platform can provide an indication to the creator that there is no suitable model available.

Creators, AI model owners, and rightsholders may wish to interact with the platform in a variety of ways. For example, creators who want to use the platform may interact with the platform via a web site, dedicated mobile application, dedicated desktop application, and so forth. In some implementations, interaction with the platform can be integrated into content creation software so that new assets can be produced from within the content creation software. Content creation software can include, for example, image editors, word processors, presentation software, vector editing programs, desktop publishing programs, web design programs, and so forth. Any of these or other types of software can be implemented as native software that runs on a particular operating system, as cross-platform software that utilizes a framework such as Electron to run on a variety of operating systems, and/or as web applications used from within a web browser. For example, software can provide an API or other plugin architecture that can be used to allow the platform's services to be available from within an application. This can offer significant efficiencies as compared to leaving the content creation software to use the platform. For example, a web designer who wants to insert an AI-generated header image for an article can access an interface within a web design tool that allows the web designer to request an image. The web design tool can then automatically insert the generated image into a web page. As another example, an end user who creates an image in an image editor may want to use a generative model to modify the image. In some implementations, the platform can integrate with the image editor such that the image the creator is working on can be sent to the platform and requested modifications can be applied. The modified image can then be sent back to the creator. For example, the image can be automatically updated within the image editing software. In some implementations, an end user may request processing on an entire image or other asset. In some implementations, an end user may request processing on a portion of an image or other asset, for example a particular layer of an image.

The API can be used to allow other types of software to interact with the platform. For example, in some implementations, accounting software can interface with the platform and can be used to track outgoing and/or incoming payments. For example, a company that uses the platform to generate media and/or digital assets can track payments made to rightsholders and/or model owners through the platform, or a model owner or rightsholder can track incoming payments from users of the model and/or IP. In some implementations, users can access the platform (e.g., via a web interface or API) to track model usage, IP usage, etc. For example, a rightsholder can make one or more media and/or digital asset collections available for use in generative AI models, and the rightsholder can use the platform to track usage data, such as who is licensing the asset collections, which assets sets are most popular, how asset collections are being used (e.g., for commercial or non-commercial use, for global or regional marketing campaigns, etc.), and so forth.

### License and Payment System

The license system can be a significant component of the platform. The license system can be used for controlling and tracking the use of the asset collections. The IP license system can manage licenses, help to ensure compliance with license terms, facilitate payments, and so forth.

In some implementations, the license system allows for the creation of different types of licenses. For example, the license system can enable the generation of exclusive licenses, non-exclusive licenses, limited licenses, and so forth. A limited license can be, for example, a license that restricts the use of asset collections for particular purposes (e.g., commercial or non-commercial), in particular regions (e.g., global, regional, specific countries, specific regions within a country, etc.), for particular types of content (e.g., to forbid the use of asset collections to generate violent or sexually explicit content or content that markets to children), and so forth.

In some implementations, the license system provides for version control and updates. For example, over time, a rightsholder may change the terms under which they are willing to license an asset collection. For example, a rightsholder may initially not want to allow commercial use or may limit commercial use to particular regions but may relax these limitations over time. As another example, a rightsholder may change the price for using asset collections over time. For example, if a rightsholder has an asset that is very popular, the rightsholder may set a relatively high price for using the asset to generate new assets. However, the popularity of an asset can wane over time, and the rightsholder may decrease the cost associated with using a particular asset collection over time. In some cases, an asset collection may become more valuable, for example because of renewed interest, in which case the rightsholder may increase the cost of using the asset collection.

In some implementations, the platform offers various pricing schemes. For example, the platform can allow rightsholders to selected fixed pricing, dynamic pricing, royalty-based pricing (e.g., no or a relatively low upfront price, follow by royalty payments based on usage), and/or set-you-own pricing (e.g., end users can select a price they want to pay for access to a content set (also referred to herein as an asset collection)). In some implementations, the platform enables surge pricing, such that a rightsholder can choose to dynamically adjust pricing based on demand. For example, when an asset collection is in high demand, pricing can be automatically increased, or when an asset collection is in low demand, pricing can be automatically decreased. In some implementations, surge prices can be constrained by an upper bound (e.g., a ceiling price), a lower bound (e.g., a floor price), or both.

In some implementations, the platform facilitates payments to a rightsholder. For example, when an end user uses the rightsholder's assets to generate new assets, the creator can indicate how the generated assets will be used (e.g., which regions, commercial or noncommercial, a duration of the use, etc.). The platform can use this information along with costs specified by the rightsholder to calculate a cost of the generated assets. The platform can initiate payment from the creator to the rightsholder. For example, the platform can store payment information for the creator and account information for the rightsholder, such that payment can be initiated between the rightsholder and the creator. In some implementations, the platform can implement functionality for processing payments. In some implementations, the platform can use one or more third-party payment providers to manage payments. For example, the platform can provide information about the rightsholder, the end user, and the payment amount to a third-party platform, which can handle payment from the end user to the rightsholder.

In some implementations, the platform provides for payments to a model owner. This can be accomplished in a variety of ways. In some implementations, the platform can act as a passthrough to a generative AI service. For example, an end user can purchase generic tokens via the platform that can be used with a variety of generative AI services, and the tokens can be converted when the creator uses a particular generative AI service. In some implementations, the platform can host a generative AI model, and the model owner can specify payment terms. When an end user uses the hosted generative model, the platform can initiate payment between the creator and the owner of the hosted generative model, for example as described herein with respect to payments between end users and rightsholders.

### Generation System

In some implementations, end users utilize the platform to generate content. In some implementations, the platform makes available one or more asset collections and/or one or more generative models. The one or more asset collections can include, for example and without limitation, asset collections provided by the end user, asset collections provided by a client of the end user (e.g., a client of an advertising agency can make one or more asset collections available to the advertising agency for use in generating advertising materials for the client), and/or asset collections provided by other parties.

In some implementations, the platform hosts a generative model. For example, the model can be stored in a model data store maintained by the platform and the platform can be responsible for executing the model. In some implementations, the platform can store a model definition (e.g., accepted inputs, provided outputs, model owner, etc.), but may not store the model itself.

In some implementations, the platform is configured to communicate with one or more generative AI service providers. For example, in some implementations, the platform can act as a token exchange or token reseller and can provide a middle layer for accessing a generative AI service provider's models. For example, in some implementations, an end user can purchase tokens (also referred to as credits) that from the platform, and the platform can, in response to receiving a request from the creator to use a particular generative model, convert the purchased tokens into tokens that enable the use of a generative model provided by a generative AI service provider.

In some implementations, creators can access general purpose or generally available generative models. For example, an end user can use the platform to interact with a publicly available generative model. In some implementations, end users can access one or more custom models. A custom model can be, for example, a model that is trained using assets from a particular brand, a particular company, etc. A custom model can be desirable because, for example, it can generate assets that more closely adhere to brand guidelines and/or more closely resemble a desired type of content. In some cases, a company may train a custom model and can make the custom model available to a group of creators. In some implementations, the group can be all creators who use the platform. In some cases, a custom model owner can make the custom model available to specific users. For example, a company may only make a custom model available to advertising agencies that it works with.

As one example, consider an animation company with a particular drawing style and well-known characters. If a generally available generative model is used to generate content for the animation company, the results can appear significantly different from the company's existing assets. For example, characters can have different shapes, clothing, colors, etc., and/or a drawing style can appear different from that normally used by the animation company. As another example, consider a major brand with a well-known logo, typography, etc. If a general generative model is used to generate marketing content for the brand, the logo can appear misshapen or otherwise erroneously rendered, typography can use fonts, weights, kerning, etc., that are inconsistent with the brand, and so forth. These and other issues can, in some implementations, be mitigated via the use of custom models. In some implementations, fully custom models are used. However, in some cases, generally available models can be used, and such models can be provided with instructions, examples, etc., that can improve the outputs of such models, for example to make them more consistent with a brand identity, particularly artistic style, etc.

In some cases, a model owner can license a model for use in creating custom models. For example, as described above, transfer learning can be used to create a custom model based on a more general model. A creator can supply assets for use in training the custom model, for example by uploading the assets to the platform or by providing the platform with information for accessing stored assets (e.g., information for accessing cloud storage where the assets reside).

### Verification System

One aspect of the platform is to provide end users with confidence that the assets they generate are free of unknown license restrictions or copyright violations. Unauthorized generated assets could be made available for licensing and use if, for example, a nefarious actor uploads or otherwise submits assets that they do not have ownership or an appropriate license for. For example, a bad actor could scrape content from the internet and submit it to the platform, falsely representing that they own the rights to the content. In other cases, an actor may not be nefarious but instead may simply submit assets that they do not have sufficient rights to, for example because the assets were created as a work for hire and another entity actually has the rights to them, because rights were licensed to another party, because the assets are unauthorized derivative works, because the assets were AI-generated and ineligible for copyright protection, and so forth.

Thus, it can be significant to detect IP violations, duplications, and so forth when an individual or entity submits assets to the platform. For example, IP violations could result in legal vulnerability for end users. Duplications could result in end users being overcharged for access to content or paying the wrong party for access to content.

One approach to detect duplications, IP violations, and so forth is to use one or more machine learning models to identify similar assets. For example, a machine learning model can be trained to quantify the likeness between images, video, sound, 3D models, video games, and/or other media assets and/or digital assets. In some implementations, different kinds of media are compared. For example, an image can be compared to one or more video frames, audio can be compared with an audio track from a video, etc. This can be significant as copyrighted material may be used without authorization in another type of work, such as using a song in a video or video game without authorization.

In some implementations, convolutional neural networks (CNNs) or other deep learning models are designed and trained to identify similarity between assets. For example, a CNN can learn hierarchical representations of images (e.g., edges, colors, graininess, etc.). During training, the CNN can be exposed to a dataset of images or other assets and can be trained to extract relevant features. Once trained, the CNN can be used to encode images or other assets to create embeddings.

In some implementations, similarity between assets is determined based on the similarity of their embeddings. By comparing the similarity of embeddings, duplicates or similar images, videos, songs, or other assets can be identified in a scalable, efficient manner.

In some implementations, training a model to identify similar assets involves the use of a triplet loss function. Using a triplet loss function, a reference input can be compared to a matching input and a non-matching input, and the distance between the reference input and matching input can be minimized while the distance between the reference input and the non-matching output can be maximized. In the context of detecting duplicates or other IP violations, the triplet loss function can be minimized between assets that are similar (e.g., one asset likely infringes on rights in another asset) and maximized between assets that are dissimilar (e.g., one asset is unlikely to infringe on rights in another asset).

In some implementations, Siamese networks, contrastive learning frameworks, and/or other models can be used to detect potential IP violations or other IP issues. Such models can be trained to output a high value when assets are similar and a low value when assets are dissimilar.

In some implementations, alternatively or additionally, techniques such as histogram-based comparisons, structural similarity measures, and feature-based methods can be used.

To help ensure the legitimacy of the platform and that users are not licensing content from individuals or organizations that do not actually own the rights to the content, the platform can include a verification system. In some implementations, the verification system can include a search module. In some implementations, the verification system can include a verification module. In some implementations, the search module, the verification module, or both make use of an embeddings store, a metadata store, or both. In some implementations, hashes are used by the search module, verification module, or both.

For example, in some implementations, creators and/or rightsholders can include metadata in their content, and this metadata can be stored in the metadata store. When a creator and/or rightsholder submits content to the platform, metadata can be extracted from the submitted content and compared with metadata in the metadata store. If the metadata in the submitted content matches metadata in the metadata store, this can indicate that the creator has submitted content for which the user does not own the rights or can indicate that another individual or organization previously submitted content for which they do not own the rights. In some implementations, creators and/or rightsholders can include license information, usage rights information, etc., in metadata.

In some cases, metadata may not be identical even though newly-submitted content matches previously-submitted content. For example, image EXIF data may have been edited, coloring may have been changed, edit or creation dates may differ, image resolution may have been altered, an image may have been cropped or mirrored, and so forth. Thus, in some implementations, rather than look only for exact matches, the verification module, the search module, or both can be configured to look for content that has metadata with at least a threshold similarity.

Conventional metadata (e.g., creation time, edit time, location, camera, lens, f-stop, focal length, image resolution, color space, etc.) can be easily manipulated. Thus, in some implementations, other information can be used additionally or alternatively. In some implementations, hashes are used for identifying similar assets. In some implementations, assets are represented as vector embeddings, and the vector embeddings can be compared to determine similarity between assets.

In some implementations, the platform uses cosine similarity to detect duplicates, detect IP violations, trace the lineage of a generated asset, and so forth. Cosine similarity involves measuring the similarity between two vectors in a vector space. In some implementations, assets can be represented as vectors (e.g., embeddings). Each dimension of a vector can correspond to a specific feature or characteristic of an asset. To determine the similarity between assets, the cosine similarity can be calculated. For example, for a first asset represented by a vector \vec{A} and a second asset represented by a vector \vec{B}, the cosine similarity can be defined as \vec{A}·\vec{B}/(∥\vec{A}∥∥\vec{B}∥). The cosine similarity can range from −1 to 1, with 1 indicating identical vectors, 0 indicating no similarity (e.g., the vectors are orthogonal), and −1 representing complete dissimilarity. In some implementations, negative values may not be possible, and the cosine similarity can range from 0 to 1.

In some implementations, assets are be identified as duplicates or IP violations if the cosine similarity meets or exceeds a threshold value. Setting the cosine similarity threshold too high or too low can result in false negatives or false positives. For example, if the cosine similarity is set to 1, only exact matches will be found, leading to false negatives as even a slight modification of an asset would prevent matching. In many cases, an asset may undergo various processing operations that can change aspects of the asset. For example, in the case of an image or video, the original can be compressed, upscaled, mirrored, cropped, have its colors changed, and so forth. In some cases, part of an image or video frame can be extracted. For example, an original image may be of a person standing on a beach (or more generally, any subject on any background). An individual can extract the person from the image and place the person on another background. The images might appear quite different while still violating the IP rights of the photographer or owner of the rights in the original image. If the cosine similarity is set too high, modified images may not be detected as infringing assets. On the other hand, setting the cosine similarity threshold too low can result in false positives, in which assets that are unrelated or that do not infringe can be flagged as potential IP violations.

In some implementations, the platform's cosine similarity threshold is set relatively low, such that some false positives are tolerated in favor of having fewer false negatives (e.g., missed duplicates or IP violations). While this can create some friction for rightsholders whose assets are incorrectly flagged, such an approach can be desirable in some implementations, for example because it can decrease the likelihood that unauthorized content or duplicate content makes it onto the platform, which could place an end user in legal jeopardy or result in the creator being overcharged.

In some implementations, suspected duplicates or IP violations are flagged for human review, and assets can be added to the platform only after a human review determines that the assets are not duplicates or IP violations. It will be appreciated that manual human review of all assets submitted to the platform is infeasible, as such review would require that the platform either store or have access to every asset submitted and would require human reviewers to compare content against an infeasibly large number of other assets. Moreover, humans may perform poorly when comparing assets that have been significantly modified.

In some implementations, similarity thresholds are set differently for different assets. For example, similarity thresholds can be lower for assets that include well-known characters, logos, and so forth. Such an approach may be more effective at catching possible infringements where asset features are less clear, for example when a company's logo is shown from an acute angle or partially obscured.

In some implementations, cosine similarity or other similarity measures are performed on an entire asset or an entire portion of an asset, such as an entire image frame from a video or an entire photograph or illustration. In some implementations, assets undergo preprocessing to identify the most relevant portions of a feature or other asset (e.g., the subject of an image). For example, a first machine learning model can be trained to extract the subject from an asset such as a photo, video, or illustration. The subject can be, for example, a person, a character, a product, a logo, a structure, a landmark, etc. Similarity comparisons can, in some implementations, be performed only on the extracted subjects from different assets. This can be effective, for example, in cases where a character, logo, product, person, etc., has been extracted from one asset and placed into another asset, or when generative AI has been used to produce a new asset than includes a character, product, logo, etc., found in other assets. For example, an individual may have used generative AI to create a depiction of a famous character in another setting or in a different artistic style.

While cosine similarity is described in detail above, it will be appreciated that other metrics can be used. For example, in some implementations, Euclidian distance (also known as L2 distance) can be used. In some implementations, Manhattan distance (also known as L1 distance) can be used. In a Euclidian distance approach, the straight-line distance between points is calculated. In a Manhattan distance approach, the absolute differences along each dimension are added together. In some implementations, rather than computing cosine similarity, the dot product between two vectors can be calculated.

Cosine similarity can be desirable because it is less sensitive to the dimensionality of vectors, which can make it more suitable for high dimensional spaces. Additionally, cosine similarity is normalized and confined to a particular range (e.g., [−1,1] or [0,1]) while Manhattan distance, Euclidean distance, and dot product are not restricted to a particular limited range (for example, they may be limited to the range [0, ∞)) and the distances can be influenced by the number of dimensions.

### Content Submission Processing

In some implementations, the platform offers support for various types of assets, such as images, audio, video, and text. In some implementations, an end user can use various types of assets when generating an asset. For example, an end user may want to make use of video when generating images or may want to use text when generating images or video. Accordingly, in some implementations, the platform enables rightsholders to submit a wide variety of content and/or enables end users to select different types of content for use in generating new assets.

Different types of assets can be ingested into the platform in different ways, although there can be common operations of an ingestion process (though the specific implementation of various operations can differ for different types of assets). For example, when a rightsholder submits content, the platform can create a new repository for storing a content set, can extract metadata from the content in the content set, calculate hashes for the assets, calculate embeddings for the assets, determine similarity to other assets, identify duplicates, identify potential IP violations, apply various transformations, apply watermarks, and/or create a searchable index.

In some implementations, the platform receives a submission comprising images. Metadata can be extracted from the images and/or associated with the images. Metadata can include, for example, copyright information, license type, creation date, photographer/creator, image source, usage rights, image ID, keywords/tags, file format, resolution, location information, model/property release status, contact information, attribution requirements, modification rights, distribution history, and/or generative AI prompt history. Copyright information can identify the copyright holder of the image. License type can specify the type or types of licenses available, and content restrictions, etc. For example, the license type can indicate if the image is rights-managed or royalty-free). The creation date can indicate a date when the image was created. The photographer/creator can indicate the name of the photographer or creator who made the image. The image source can indicate where the image originated. For example, if the image did not originate from the creator, the image source may indicate that the image was obtained from a stock photo agency or other source. Usage rights can include detailed information related to where and/or how the image can be used. For example, the usage rights can indicate if an image can be used for commercial use, educational use, editorial use, and so forth. In some cases, the usage rights can include an expiration date after which the image cannot be used. The image ID can be a unique identifier that can be used for tracking the image within a database or system. The keywords/tags can be relevant keywords/tags that describe, for example, image content, theme, subjects, and so forth. In some implementations, the keywords/tags can be used when searching for content on the platform.

The file format can indicate a format for the image, such as JPG, TIFF, HEIC, GIF, PNG, etc. The resolution can indicate the size of the image in pixels, which can be used to, for example, evaluate its quality and/or suitability for use in various scenarios (e.g., a low quality image may not be well-suited to generating high resolution content). Location information can include geographic information about where the image was taken. Model/property release status can indicate if a release has been obtained from a model or property depicted in the image. The release can indicate, for example, whether the model/property consents to use of the image in commercial contexts. Contact information can indicate how to contact the copyright holder or licensing agency for permissions, negotiations, and so forth. In some implementations, the metadata can include information about the cost of licensing the image for different applications. Attribution requirements can include information about attribution that is required when using the image. In some implementations, attribution requirements can include any technical and/or encryption measures used to protect the image from unauthorized use. Modification rights can indicate what, if any, modifications are permitted. In some implementations, the metadata can include information about any alterations or edits made to the original image. If generative AI was used to create the image, the generative AI prompt history can include, for example, a log of a prompt or prompts used to create the image.

In some implementations, the platform provides the received images to a machine learning model, which can be configured to output a text-based summary of the content. The summary can describe, for example, the location of the image, an object depicted in the image, a person depicted in the image, a time the image was taken (e.g., morning, day, dusk, night, etc.), a season when the image was taken, weather conditions when the image was taken, and so forth. In some implementations, the platform can provide the summaries in a searchable manner, such that an end user can search for a type of image they are looking for and receive appropriate results. For example, if a user searches for “rolling landscape at night during a thunderstorm,” the system can search the summaries for images of landscapes at night where rain or lightning are present.

In some implementations, the platform applies a watermark to received images. In some implementations, a watermark can be applied via, for example, least significant bit substitution or noise injection. In some implementations, C2PA specifications can be followed when applying a watermark to an image.

In some implementations, the system computes one or more hashes for each received image. A hash can include, for example a perception hash, average hash, and/or difference hash. In some implementations, a hash such as a perception hash can be advantageous because, for example, similar images can be expected to have similar hashes. Thus, hash similarity can be used in some implementations to determine if two images are the same or modifications of each other. As described herein, in some implementations, a part of an image (e.g., the subject of an image) can be extracted from an image. In some implementations, the platform can be configured to calculate one or more hashes for an extracted portion of an image. While described in the context of images, it will be appreciated that such hashes can also be used for other types of assets, such as video, audio, or text.

In some implementations, the platform calculates embeddings for each received image. For example, in some implementations, the platform determines embeddings using a contrastive language-image pretrained (CLIP) model, such as ViT-H-14, or a residual neural network (ResNet). Any suitable model can be used to generate embeddings.

In some implementations, the platform receives a submission comprising video. Metadata can be extracted from the videos and/or associated with the videos. Metadata for videos can be similar to metadata for images. Metadata for videos can include, for example and without limitation, copyright information, license type, creation date, producer/creator, video source, usage rights, license expiration date, video ID, keywords/tags, file format, resolution, location information, model/property release status, contact information, attribution requirements, modification rights, distribution history, usage restrictions, edit history, duration, audio rights, subtitles/captions, format/codec, bitrate, color profile, and/or generative AI prompt used to create the videos.

There can be video-specific metadata such as duration, audio rights, subtitle availability, format/codec, bitrate, color profile, etc. This information can reflect the additional complexity of video as compared with images. In some cases, different rights can be associated with different portions of video. For example, the visual content of a video can be subject to certain license restrictions, while an audio track associated with the video can be subject to other license restrictions, which can be the same as or different than license restrictions associated with the visual content. Video content can include additional tags, such as the director, cast, and so forth.

In some implementations, processing is carried out with respect to video that is similar to or the same as that performed on images. For example, video, video clips, and/or video frames can be analyzed to determine the setting, subjects depicted, and so forth. In some implementations, a script (e.g., based on the subtitles if present or based on text converted from an audio track) is used to determine addition information about the video. For example, the script can be provided to a large language model for summarization. The summarization can describe, for example, events that take place in the video, dialog that occurs in the video, and so forth. In some implementations, a script is not provided and platform can provide the video (or an audio track of the video) to a speech to text model for transcription.

In some implementations, script summaries, summaries of what is depicted in videos, video clips, video frames, and so forth are made searchable, thereby enabling a user to more easily find desired video content.

In some implementations, a larger video is divided into one or more video clips. The video clips can be shorter videos that are extracted from the larger video. A video clip can be, for example, a scene, part of a scene, a frame, and/or the like. Dividing a larger video into clips can have several advantages. For example, an end user may want to base generated content in part on a specific scene in a video. Transferring large videos can consume significant network resources. In some cases, a machine learning model may have a limit on how long and/or how large a video that is submitted to the machine learning model can be.

In some implementations, audio and visual content from a video are licensed differently, or an end user may only want to license the audio or the visual content, but not both. For example, an end user who wishes to make a generative AI image with a look similar to that of a video may not want to license the audio for the clip. Depending on which model an end user selects for generating new assets, the model may accept only video frames, only visual content, only audio content, etc.

In some implementations, the platform maintains a database or other data store that maps larger videos, video clips, and/or audio clips to one another. For example, when video clips and/or audio are extracted from a larger video, it can be beneficial to track where the video clip came from in the larger video. Similarly, it can be beneficial to keep track of the timestamp of audio within a video. In some implementations, audio and visual content can be stored separately and can be merged when both the visual and audio content are needed. Such an approach can, for example, save storage space as video files can be stored without audio.

In some implementations, clips from a same video are stored in a related content set or the platform can otherwise store information indicating that the clips are related. This can be helpful if, for example, an end user wants to locate additional content that is similar to content they have selected to use for generating AI content.

In some implementations, a video is split into one or more clips, for example using moviepy, opencv-python, pillow, matplotlib, pandas, etc.

In some implementations, the platform is configured to determine one or more hashes for each video, video clap, extracted audio track, etc. A hash can be, for example, a perception hash, average hash, and/or difference hash.

In some implementations the platform is configured to determine embeddings for a video, video clip, etc. For example, the platform can be configured to use a CLIP model such as ViT-H-14. It will be appreciated that any suitable model can be used to generate embeddings.

In some implementations, the platform is configured to inject a watermark into received and/or processed videos. For example, in some implementations, the platform uses least significant bit substitution or noise injection. In some implementations, the platform follows C2PA specifications when injecting watermarks.

In some implementations, the platform receives a submission that includes audio. Metadata can be associated with and/or extracted from the provided audio files. Metadata for an audio file can include, for example and without limitation, copyright information, license type, creation date, composer/artist, publisher, usage rights, license expiration date, audio ID, keywords/tags, format, bitrate, sample rate, channels, duration, usage restrictions, distribution history, price, contact information, performance rights organization (PRO) information, international standard recording code (ISRC) information, lyrics and/or lyrics availability, instrumental version availability, language, and/or generative AI prompt used to create the audio.

Audio-specific metadata such as duration, lyrics, sample rate, PRO, ISRC, and bitrate can reflect the complexity and additional considerations when managing audio content for licensing. The publisher can indicate the entity responsible for distributing the audio. The file format can be the format of an audio file, such as MP3, AAC, WAV, FLAC, etc. The sample rate can indicate the number of samples of audio per second. Channels can indicate the number of channels (e.g., mono, stereo, surround (e.g., 5.1, 7.1, etc.), etc.) PRO information can include details about the organization that manages rights and royalties for the audio. ISRC can be a unique code for identifying specific recordings. Lyrics availability can indicate whether lyrics are available for and/or included with the audio. Instrumental version availability can include whether or not there is an instrumental version of the audio available. In some implementations, audio-specific tags can be used, such as artist, album, track number, genre, year, and so forth.

Audio data can present special considerations for licensing. For example, a copyright can exist in a musical work as well as in a sound recording. The musical work can be a song's underlying composition and can include any lyrics. The sound recording can be a series of sounds affixed in a recording medium (e.g., a CD, cassette, record, digital file, etc.). In some cases, a rightsholder may want to license a composition and lyrics separately.

Rightsholders may want to impose various restrictions on licensed audio content. For example, a rightsholder may want to allow streaming use, but may not want an end user to make generated content available for permanent downloaded by consumers, or a rightsholder may want to provide streaming rights but not other public performance rights, such as allowing generated content to be used in stores, broadcast via radio, played at public performances, etc. In some cases, a rightsholder may wish to allow generated audio that uses the rightsholder's content to be used in a standalone manner but may not want the generated audio to be used in other ways, for example as part of a soundtrack for a video.

In some implementations, the platform generates an image representation of an audio file, for example using LibROSA, SciPy, TensorFlow, PyTorch, matplotlib, Audiolab, or another library or module. In some implementations, the platform splits audio, for example using pillow, matplotlib, pandas, and/or the like. In some implementations, the platform calculates one or more hashes for each file, for example a perception hash, average hash, and/or difference hash.

In some implementations, the platform calculates embeddings, for example using a CLIP model such as ViT-H-14. It will be appreciated that any suitable model can be used to calculate embeddings.

In some implementations, the system injects watermarks into received audio files and/or into images generated from received audio files. For example, the platform can use least significant bit substitution or noise injection to inject a water. In some implementations, the platform follows the C2PA specifications when injecting watermarks. In some implementations, the platform can use the wavmark watermarking tool to watermark audio files. Wavmark can be advantageous because, for example, it can be more robust against common attacks such as Gaussian noise, MP3 compression, low pass filtering, speed variation, and so forth than some other audio watermarking techniques.

A submission can include text files, such as PDFs, word processing documents, LaTeX files, plain text, Markdown files, and so forth. In some implementations, the platform extracts metadata from and/or associate metadata with the received text files. Metadata for a text file can include, for example, copyright information, license type, creation date, author/creator, publisher, usage rights, license expiration date, text ID, keywords/tags, file format, word count, language, usage restrictions, distribution history, price, contact information, abstract/summary, ISBN/ISSN, publication date, edition, citation information, accessibility features, and/or a generative AI prompt used to generate the text file. The publisher can indicate the entity responsible for publishing the text. The abstract or summary can include a brief description or summary of the text. The ISBN or ISSN can indicate the International Standard Book Number or International Standard Serial Number for a book or periodical. The publication date can indicate the date the text was published or otherwise made available for the public. The edition can indicate an edition or version of the text. The citation information can indicate a recommendation citation format, citation details, and/or the like. Accessibility features can indicate if there is information or features that make the text accessible to users with disabilities, such as alt text for images or structured headings for screen readers.

In some implementations, the platform supports source code. Source code can be a type of text content. Source code can be written in a particular language (e.g., Python, Java, C, C++, JavaScript, etc.), can be targeted at a particular version of a language, can implement certain functionality, etc. In some implementations, the platform includes a code inspection module that can, for example, determine the language a source code file is written in, dependencies (e.g., included header files or libraries), functions, classes, etc. In some implementations, the platform can determine functionality of the source code. Such analysis can be useful for determining for example, if source code is directly copied, if functionality is replicated, and so forth.

In some implementations, the platform splits received text content, for example using a module such as re, os, and/or textwrap. In some implementations, the platform can be configured to chunk text into knowledge units, for example using a knowledge unit extractor model. In some implementations, the knowledge unit extractor model uses, for example, a large language model, to process text. In some implementations, a knowledge unit can be a chunk of text that represents a complete idea, story, sub-story, story arc, chapter, section, or any other chunk of text. In the context of code, in some implementations, a knowledge unit can be, for example, a function, library, class, etc.

In some implementations, the platform determines embeddings for the text, for example using a model such as Ada-Large. In some implementations, the platform determines embeddings for a textual work as a whole. In some implementations, the platform can determine embeddings for knowledge units.

In some implementations, the platform inserts a watermark, such as an overlay on top of text, a small text portion that only appears on screen, an LLM compliance warning, and so forth.

While specific examples of types of content that can be received and processed by the platform are described herein, it will be appreciated that the approaches described herein are not limited to the specific examples. Rather, in some implementations, the approaches herein are adapted for use with any type of binary or plain text file. Binary files can include, for example, executables, image files, audio files, video files, 3D object files, compressed archives, binary document files, binary data files, etc.). Plain text files can include, for example, HTML files, CSS files, markup files such as XML or JSON files, markdown files, vector graphics files (e.g., SVG files), source code, etc.

### Rights Verification

As described herein, it can be important to verify that those who submit content actually own the rights to the content. This can be a challenging task, as rightsholders may maintain public records of, for example, copyright registrations, assignment agreements, and so forth. However, even in cases where such information is publicly available or available from a third party such as a rights management organization, it can be difficult to obtain such information.

In some implementations, a platform includes functionality for retrieving data from a governmental intellectual property office, for example the U.S. Copyright Office, the U.S. Patent and Trademark Office, or other government intellectual property offices. In some implementations, the platform can be configured to retrieve data from a rights organization.

### Licensing

In some implementations, the platform facilitates licensing agreements between rightsholders and content creators. In some implementations, a platform can facilitate the creation of licensing and/or moderation terms in cooperation with AI service providers and rightsholders. For example, in some implementations, the platform access moderation rules in place for various generative AI models and can provide these rules in an interface displayed to a rightsholder. The rightsholder can review the moderation rules and select models having moderation rules that are in line with the rightsholder's desires. In some implementations, the rightsholder can provide additional moderation terms to the platform. For example, a rightsholder can specify one or more excluded or restricted content sets, can exclude certain prompt scenarios (e.g., requests for generated content that is sexually explicit, depicts violence, depicts drug or alcohol use, and so forth).

When a licensee accesses the platform, the licensee can find one or more content sets that they wish to use to provide new assets using generative AI. The platform can receive the selection and can show the allowed model(s) and moderation terms to the licensee. For example, the platform can, based on the selected content sets, determine which models can be used with all the selected content sets. In some cases, there may be a single model available. In some cases, there can be multiple models available. In some cases, there may be no models available, for example because the selected content sets do not share at least one common allowed model.

### Moderation

As described herein, it can be important to enforce certain moderation rules. In some implementations, moderation rules can relate to how a rightsholder wants their content to be used. For example, a rightsholder may want to disallow certain prompt scenarios (e.g., sex, drug use, violence, etc.) or otherwise restrict the content that can be generated using their IP.

Moderation rules can help ensure compliance with regulations. For example, different regions can be subject to different privacy regulations and so forth. In some implementations, a platform uses an application programming interface to retrieve relevant regulations. Such an approach can be important because regulations can change frequently.

Regulations can vary depending upon where an end-user is located. For example, different countries may have different restrictions on content that can be generated, different privacy and/or publicity rights when depicting individuals, and so forth. Thus, in some implementations, a platform implements functionality to determine where an end user is located, which can reduce the likelihood of violating relevant local laws and regulations. Various approaches can be used to determine where an end user is located. In some implementations, the platform can use IP address geolocation, GPS services, the HTML geolocation API, Wi-Fi network triangulation, cellular network triangulation, and/or other location determination methods. However, it will be appreciated that such approaches may not always provide accurate location information. For example, an end user can disable geolocation services, deny location requests, use a virtual private network (VPN) to mask their location, and so forth.

In some implementations, efforts to mask location are detected at least in some cases. For example, if an end user is using a VPN, the platform can block access based on block-listed IP addresses that are known to be assigned to VPNs, can integrate with a VPN detection service, can analyze end user behavior (e.g., inconsistent language selections, etc.), and so forth.

### Example Implementations

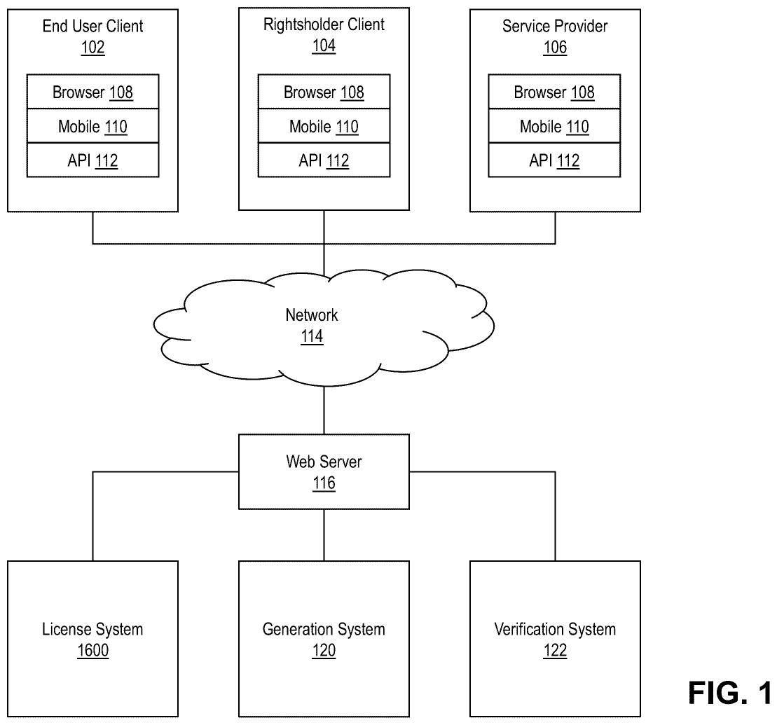

FIG. 1 is a diagram that illustrates various components of a system for carrying out the methods described herein according to some implementations. An end user client 102, rightsholder client 104, service provider 106, or any combination thereof can communicate with a platform via a browser 108, mobile device 110, API 112, or any combination thereof over a network 114 with a web server 116. In some implementations, individuals access the platform via a plugin, application, extension, etc. In some implementations, an end user, rightsholder, and/or service provider may interact with the platform via an application (e.g., a desktop application, mobile application, and/or web application). In some implementations, an end user, rightsholder, and/or service provider may communicate with the platform using a plugin or extension to another application. The web server 116 can communicate (e.g., over a local network, a wide area network, the internet, etc.) with a license system 1600, a generation system 120, a verification system 122, or any combination thereof. In some implementations, the web server 116, license system 1600, generation system 120, and verification system 122 can be the same system, can be virtual machines, can be different containers on a system, can be different systems, and so forth. The platform components shown in FIG. 1 will be described in more detail below. It will be appreciated that various features can be implemented in different systems or components of the platform, and/or that the platform can include different, additional, and/or fewer systems or components than shown in FIG. 1. Moreover, systems and/or platform components can be combined or separated in different ways while still being consistent with the present disclosure.

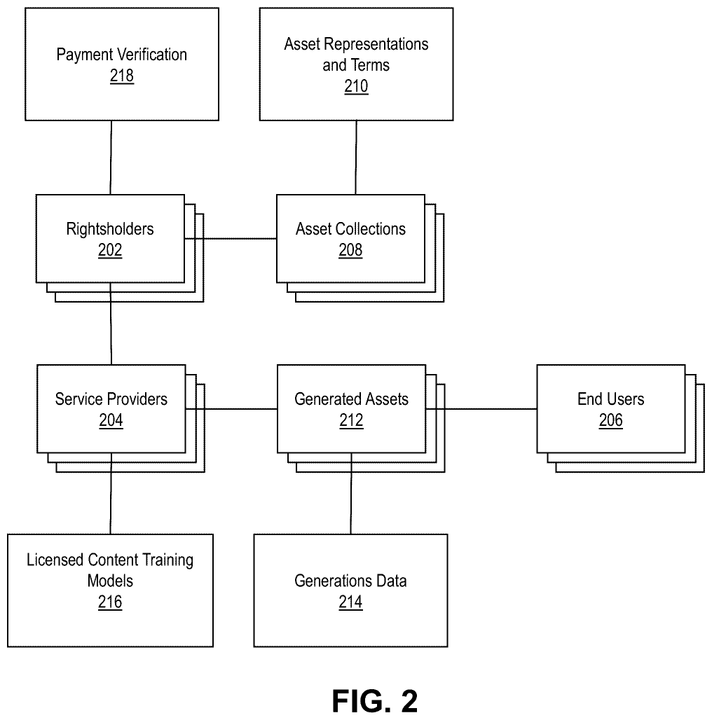

FIG. 2 is a block diagram that illustrates the relationships between different platform users and different aspects of the platform. Users can include rightsholders 202, service providers 204, and creators 206 (also referred to herein as consumers). The rightsholders 202 can upload or otherwise provide asset collections 208 to the platform that can be used by one or more generative models to generate new assets. Rightsholders 202 can interact with a payment verification module 218 to arrange for payments. The service providers 204 can provide one or more machine learning models, such as licensed content training models 216. The creators 206 can use the platform to create generated assets 212. For example, the creators 206 can use one or more models provided by the service providers 204 to generate content, and the one or more models can be trained using the asset collections 208 provided by the rightsholders 202.

The asset collections 208 can have content representations and terms 210 associated therewith. The terms 210 can include, for example, embeddings, usage terms, moderation terms, payment terms, and so forth. The embeddings can be vector representations of the content in the asset collections 208. The usage terms can include, for example, limitations on who can use the content and how the content can be used. For example, an entity may want to allow non-profits or individual non-commercial creators to use its content but may not want to allow commercial use of its content. The moderation terms can indicate types of assets that can be generated or to indicate particular generative models that can be used in conjunction with a rightsholder's content. The generated assets 212 can have generations data 214 associated therewith. The generations data 214 can include, for example, quality scores, prompts, licenses, lineage, and so forth. The quality score can indicate an overall quality of the generated asset. The prompt can be a prompt used to generate an asset. The license can be a license associated with the generated asset. For example, depending upon the terms set by rightsholders 202, a generated asset may have license terms that allow or forbid commercial use, limit the time period over which the generated asset can be used, limit geographic or political regions in which the generated asset can be used, and so forth. Rightsholders 202 can change their usage terms, moderation terms, and/or payment terms over time. Thus, it can be significant to associate the specific terms applicable to a generated asset with the generated asset. Lineage information can include, for example, a list of assets used in generating an asset.

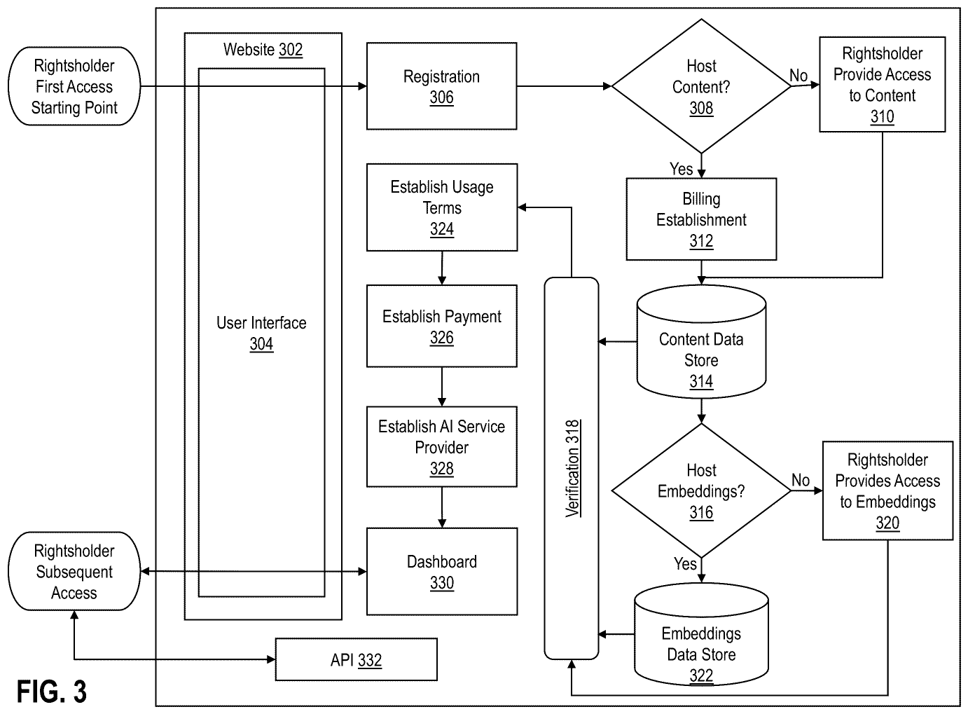

FIG. 3 illustrates a rightsholder onboarding and access process according to some implementations. When a rightsholder first accesses the platform, the rightsholder can access a website 302 having a user interface 304. The rightsholder proceeds to a registration operation 306 where the rightsholder can provide information such as an email address or contact information, create a username, create a password, and so forth. At decision point 308, the rightsholder can choose whether they want the platform to host content or whether they will self-host or utilize a third party to host the content. If the rightsholder indicates that they do not want the platform to host the content, the rightsholder can, at operation 310, provide access to the content, for example providing credentials or other information needed to access content on a cloud storage service (e.g., an Amazon Web Services S3 bucket). If, at decision point 308, the rightsholder indicates that they do want to host content on the platform, the rightsholder can proceed to operation 312 to establish billing. For example, the rightsholder can be charged a fee for storing content, a fee for accessing content, and so forth. After establishing billing, the rightsholder's content can be copied to a content data store 314.

At decision point 316, the rightsholder can choose whether they want to host embeddings on the platform or host embeddings themselves or using a third-party service. If the rightsholder does not want to host embeddings on the platform, the rightsholder can, at operation 320, provide access to the embeddings. Providing access to the embeddings can be similar to or the same as providing access to the content. If the rightsholder does want to host embeddings on the platform, the embeddings can be stored in an embeddings data store 322. The embeddings can include embeddings specific to the platform (e.g., for use in determining lineage), embeddings that can be provided to a generative AI model to generate assets, embeddings that can be provided to a generative AI model to train the generative AI model, or any combination thereof. At operation 318, the content and embeddings can undergo a verification process. In some implementations, the verification process can be entirely automated, for example using one or more ML models designed to identify similarities between the content, embeddings, or both provided by the rightsholder and other content, embeddings, or both to which the platform has access. In some implementations, human verification can be a part of the verification process. For example, a human can review assets to determine if there are obvious IP violations (e.g., if an “IP owner” uploads images or other assets that clearly belong to another entity or are unauthorized derivative works of the assets of another entity). In some implementations, a verification process can include verifying metadata. In some implementations, a verification process can include verifying blockchain transaction. After the verification process, at operation 324, the rightsholder can establish usage terms. The usage terms can include, for example, limitations on the types of assets that can be created using the rightsholder's assets, limitations on generative models that can be used to generate assets based on the rightsholder's content, and so forth. At operation 326, the rightsholder can establish payment. For example, the rightsholder can provide bank account information for depositing payments, choose how often payments are made, and so forth. At operation 328, the rightsholder can establish an AI service provider. For example, the rightsholder can select one or more AI service providers that the rightsholder's content can be used with. At operation 330, the rightsholder can be presented with a dashboard. The dashboard can provide an overview of information such as pending payments, recent payments, pending billing (e.g., where the rightsholder's content is hosted by the platform), recent billing, usage of the rightsholder's content, number of assets, types of assets, size of assets, and so forth.

Once a rightsholder has gone through the onboarding process described above, the rightsholder can subsequently access the platform, for example to update information, change terms (e.g., change the cost of using the rightsholder's content), upload new content, remove existing content, change payment information, change contact information, and so forth. The rightsholder can access the website 302 and be directed to the dashboard. Alternatively or additionally, existing rightsholders who use the platform can access the platform via an API 332. The API 332 can be configured to allow the rightsholder to perform some or all of the functions available on the website 302. API access can provide many benefits, such as allowing the rightsholder to integrate the platform with other software, such as IP management software, content management software, accounting software, and so forth, which can simplify use of the platform and allow easier automation of the use of the platform.

In addition to content creators, the platform can also enable model owners to offer their models. For example, in some implementations, model owners can provide pre-trained models and/or custom models. Custom models may be especially beneficial to larger clients, such as large content creation companies, advertising agencies, and so forth. Custom models can help ensure that generated content adheres to brand guidelines, a content creation company or advertising agency's look and feel, and so forth.

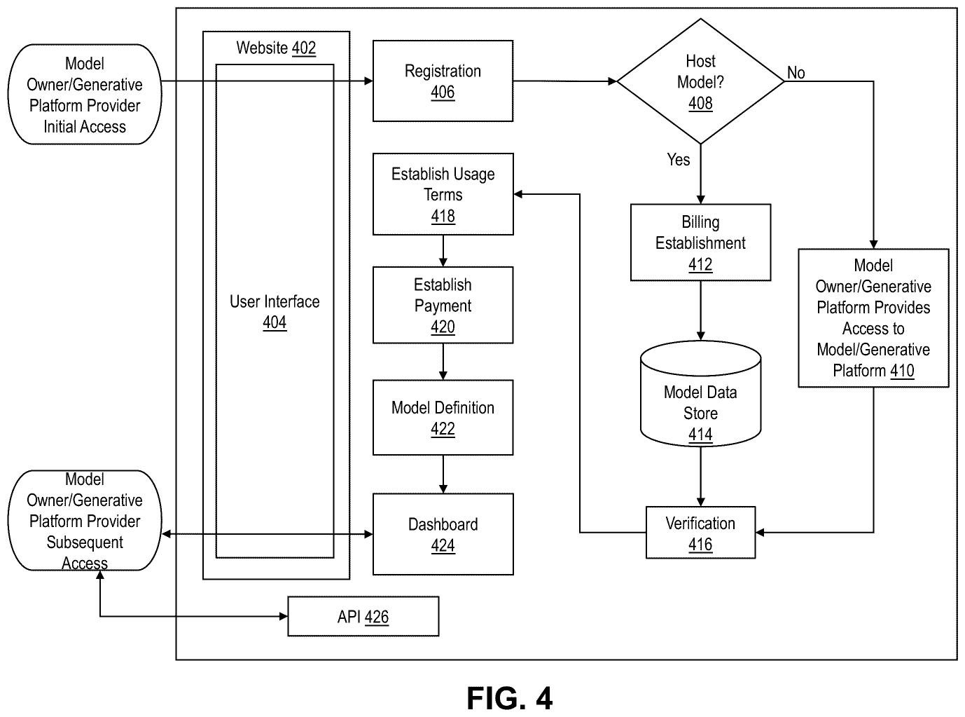

FIG. 4 is a flowchart that illustrates example processes for initial and subsequent access to a platform by a model owner. Beginning with model owner initial access, in which case the model owner does not have an account and has not previously used the platform, the model owner can access a website 402 having a user interface 404. At operation 406, the model owner can register for an account. At decision point 408, the model owner can indicate whether they want the platform to host their models or if they will self-host their models. If the model owner indicates that they will be responsible for hosting the models, the model owner, at operation 410, provides information needed for the platform to access the models. If the model owner indicates that they do want the platform to host their models at decision point 408, the model owner can proceed to operation 412 to establish billing. For example, the platform can charge fees to store the models, to perform computations with the models, and so forth. The models can then be stored in model data store 414. Models can have a wide range of sizes and/or computational complexity. Thus, in some implementations, fees can be different for different models.

At operation 416, the models can undergo a verification process. For example, the verification process can include verifying that the model owner is actually the owner of the model (or is a licensed user of the model with rights that allow them to use the model with the platform), that the model was not trained using unauthorized or unlicensed material, and so forth.

At operation 418, the model owner can establish usage terms for the model. For example, usage terms can include types of assets that can be generated using the model, allowed uses of the model (e.g., commercial or non-commercial, region restrictions, and so forth). At operation 420, the model owner can establish payment terms. For example, the model owner can set prices for using the model. Pricing can vary based on the type of creator using the model (e.g., larger organizations may pay different rates than independent creators), the type of content being generated, the intended use of the content (e.g., commercial or non-commercial, advertising, shows, movies, etc.), the regions where the content will be used (e.g., pricing can be different if an end user wants to use the generated content for an ad campaign in one country or several countries), and so forth. At operation 422, the model owner can provide a model definition. For example, the model owner can supply a model definition that includes essential metadata regarding the model (e.g., inputs, outputs, etc.). Next, the model owner can be directed to a dashboard 424. The dashboard 424 can enable the model owner to change the model, add new models, remove models, update usage terms, update billing terms, and so forth.

Turning to the model owner subsequent access entry point, in some cases, a model owner can sign in via the website 402 and be directed directly to the dashboard 424. In some implementations, the model owner can access the platform via an API 426.

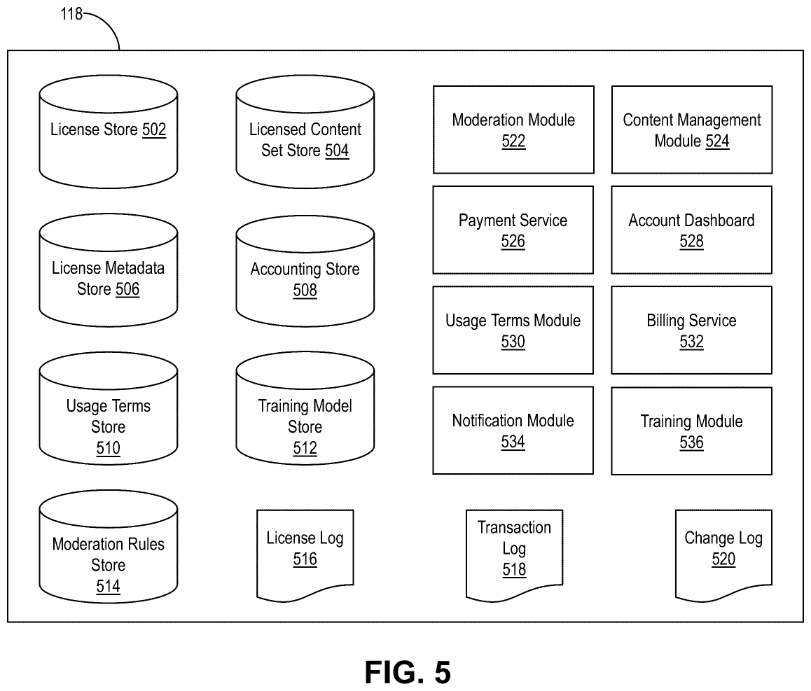

FIG. 5 illustrates a high level block diagram of various components of the license system 118. The license system can include a license store 502, licensed asset collection store 504, license metadata store 506, accounting store 508, usage terms store 510, training model store 512, and moderation rules store 514. The license system 118 can include a moderation module 522, content management module 524, payment service module 526, account dashboard 528, usage terms module 530, billing service module 532, notification module 534, and training module 536. The license system 118 can store a license log 516, transaction log 518, and change log 520.

It is expected that those who license models, assets, and so forth for use on the platform may change their usage terms, models, content, payment terms, and so forth over time. Thus, it can be significant to maintain accurate logs of usage, applicable licensing terms, and so forth.

In some implementations, logs can be stored in a database. In some implementations, logs can be stored on a blockchain. For example, in some implementations, logs can be committed to a blockchain on a regular schedule, such as after each transaction on the platform, daily, weekly, and so forth. In some implementations, all activity for all users on the platform can be rolled up and committed to a blockchain on a regular basis, for example daily. In some implementations, the activity for each user of the platform can be rolled up and committed to the blockchain on a regular basis, for example daily. Such an approach can be significant because, for example, it can limit computational resources required to maintain the blockchain while providing each user of the platform with an accurate log of their activity on the platform.

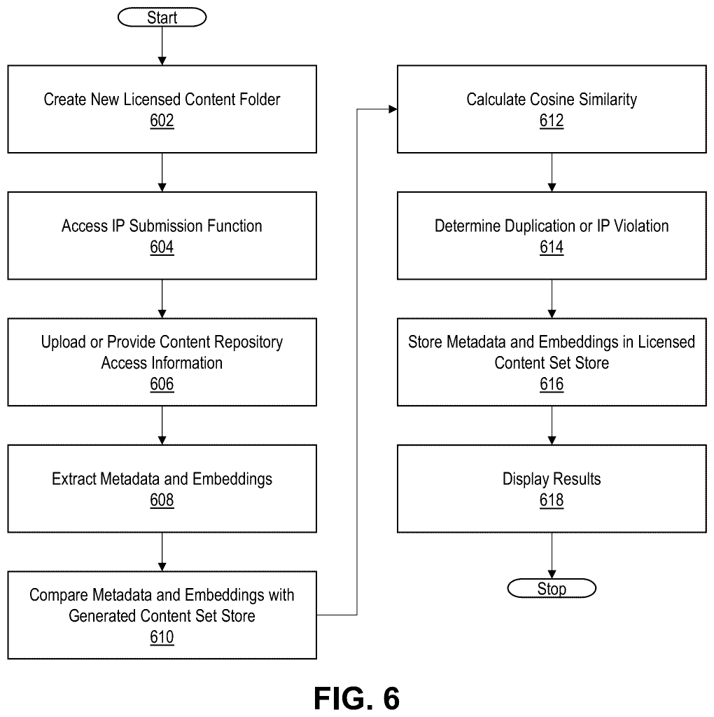

FIG. 6 is a flowchart that illustrates an example process for submitting content to the platform. At operation 602, a rightsholder can create a new licensed content folder. The new licensed content folder can be a folder on a filesystem and/or could comprise, for example, labels or tags to be applied to content being submitted. That is, the licensed content folder is not limited to a folder on a filesystem but could be embodied as any suitable organizational method, such as a database configured to store binary objects. At operation 604, the rightsholder can access an IP submission function. At operation 606, the owner can upload content to the platform or provide the platform with information needed to access a content repository (e.g., login information, a special URL, etc.). At operation 608, the platform can extract metadata and embeddings from the content. In some implementations, the rightsholder can extract the metadata, the embeddings, or both, and can provide the metadata, embeddings, or both to the platform.

At operation 610, the platform can compare the metadata and/or embeddings with existing content in a content store. At operation 612, the platform can calculate similarity (e.g., cosine similarity) between the new content and existing content in the content store or in other content, such as content scraped from the internet. In some implementations, other comparison techniques can be used alternatively or additionally. At operation 614, the platform can, for example based on comparing metadata, comparing embeddings, and/or calculating metrics such as cosine similarity between embeddings, determine if the new content contains duplicates of existing content or IP violations. For example, the new content may not actually belong to the individual or organization submitting the content, may be unauthorized derivative works of other content, may include content that does not comply with a policy (e.g., violent, obscene, or defamatory content), and so forth. In some implementations, operation 614 can include human review. The human review can be used, for example, to identify obvious copyright, trademark, right of publicity, and other violations. As just one example, an individual can create fan art that depicts characters for which another company has IP rights, and the fan art can constitute an unauthorized derivative work. In some cases, derivative works may be permitted on the platform. For example, a copyright owner of an original work can allow some derivative works but can require that compensation be directed to the original owner. In some cases, a rightsholder may have obtained a license outside the platform, and the rightsholder can provide licensing information to the platform so that the process can continue. At operation 616, after determining that the submitted content is not a duplicate of existing content and does not violate IP rights (or is unlikely to violate IP rights), the platform can store metadata and embeddings in a licensed asset collection store. At operation 618, the platform can display results to the rightsholder. The results can be displayed on a dashboard, submission confirmation page, etc. In some implementations, the results can be provided via an API. The results can include, for example, a summary of the content that was submitted, whether or not the content (or individual assets) was accepted or rejected, and so forth.

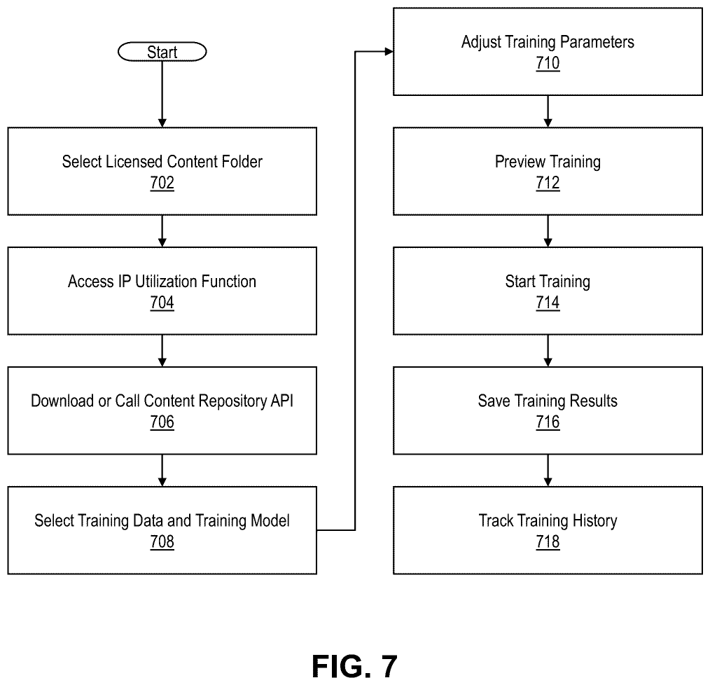

FIG. 7 is a flowchart that illustrates an example process for training a model on an asset collection according to some implementations. The process shown in FIG. 7 can be used by, for example, a rightsholder, creative agency, and so forth to train a model to produce content that adheres to a desired look and feel, brand guidelines, etc. At operation 702, a user can select a licensed content folder. As discussed above, a folder can be a folder on a filesystem, but this is not necessarily the case. For example, selecting a folder may instead comprise selecting one or more tags or labels associated with content. At operation 704, the platform can access an IP utilization function. At operation 706, the platform can download the content in the selected folder or call a content repository API to access the content in the selected folder. At operation 708, the user can select training data, which can, in some cases, include some or all of the content in the selected folder, and can select a model for training. At operation 710, the user and/or the platform can adjust training parameters. At operation 712, the platform can generate a training preview. Upon confirmation, the platform can begin training at operation 714. After training the model at operation 714, the platform can save the training results at operation 716. At operation 718, the platform can track the training history. For example, models can be updated over time via additional training. It can be significant to maintain snapshots or checkpoints of models so that their evolution over time can be traced, so that previous versions can be used, and so forth. For example, a company can use a model to generate marketing materials. As the company's brand language evolves over time, the model can be updated. If the brand decides to release a retro product or relaunch an older ad campaign, previous versions of the model can be used to generate marketing content that matches the look and feel of older content.

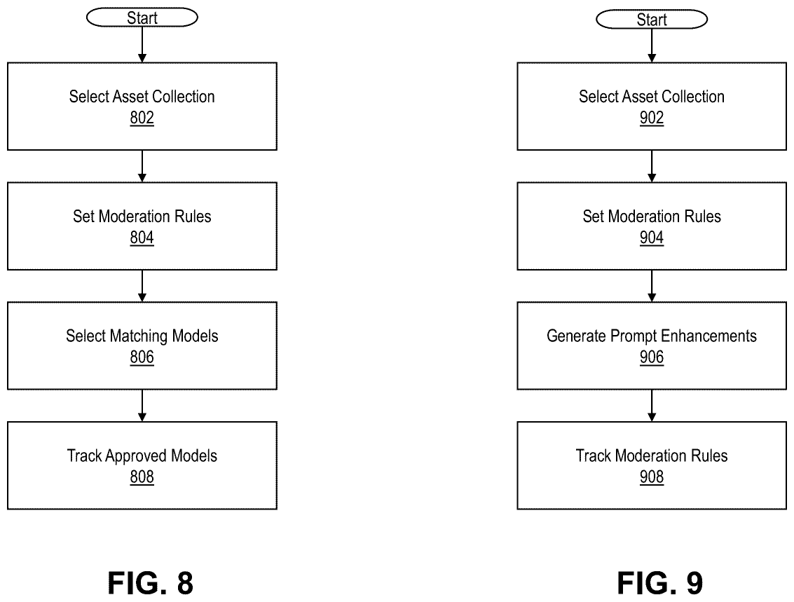

As described herein, rightsholders may want to impose various restrictions or moderation rules on how their IP can be used. FIG. 8 illustrates one example process for applying moderation rules. At operation 802, the rightsholder can select an asset collection. At operation 804, the rightsholder can set moderation rules for the asset collection. The moderation rules can include, for example, restrictions on the generation of violent or pornographic assets. At operation 806, the platform can identify models that match the selected moderation rules, and the rightsholder can select which models are approved for use with the asset collection. At operation 808, the platform can track approved models. The approved models can change over time. For example, a rightsholder may wish to expand their revenue by allowing their content to be used on more models or may wish the further restrict use of their content and select fewer models. Model owners can change their policies over time, which can impact whether or not a particular model is approved for a particular asset collection.

The process illustrated in FIG. 8 can be a relatively low risk approach to moderation for the platform provider. In such an approach, the platform is not involved in regulating content, but merely maintains a mapping of content and the models that are allowed to be used with the content. The model owners can be the ones ultimately responsible for ensuring that their own policies are followed.

In some implementations, the platform may take a more active role in enforcing moderation rules. FIG. 9 is a block diagram that illustrates an example moderation process according to some implementations. In FIG. 9, a rightsholder selects an asset collection at operation 902. At operation 904, the rightsholder selects one or more moderation rules. At operation 906, the platform can generate or select prompt enhancements that can be used to enforce the rules. For example, if a rightsholder does not want their IP to be used to market to children and an end user submits a prompt such as “Generate an advertisement showing three people consuming the product,” the platform can append the prompt to say, for example, “Generate an advertisement showing three people consuming the product. Do not include children in the output.” Such an approach can be effective, but can shift responsibility to the platform, and such an approach relies on the model both understanding and respecting the prompt enhancements. At operation 908, the platform can track the moderation rules.

In some cases, a model owner can upload their models to the platform or otherwise make models available for licensing by users of the platform. In some cases, a model owner can be a service provider that provides a service for generating assets, or the service provider can provide asset generation services using models developed by others. In some implementations, the platform can enable creators to interact with service providers.

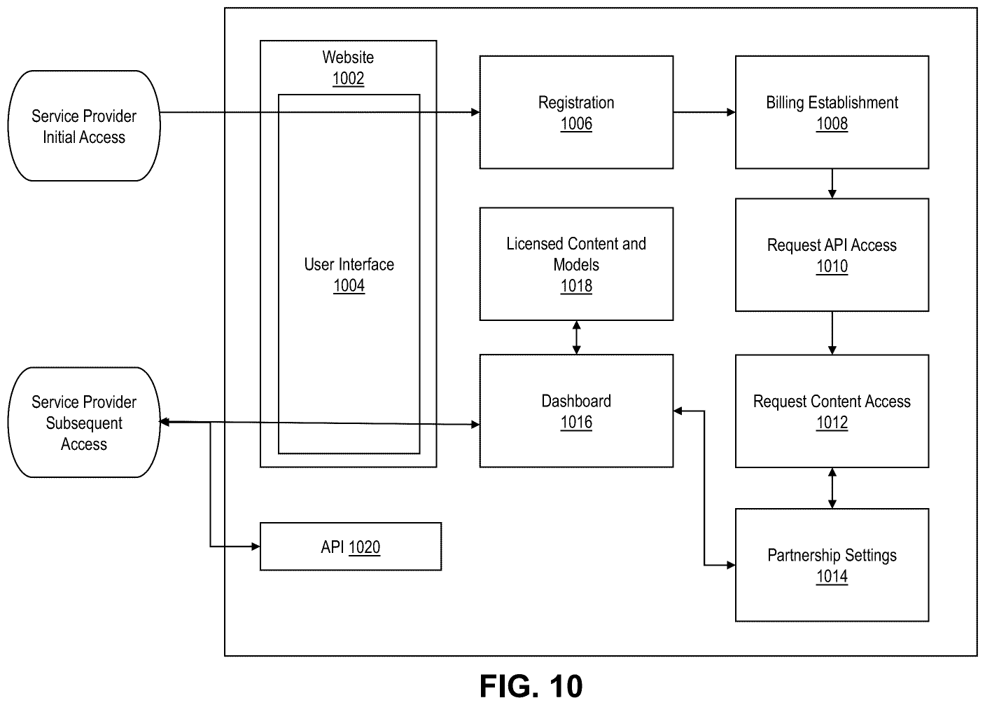

FIG. 10 is a flowchart that illustrates initial access and subsequent access process flows for service providers according to some implementations. Beginning with the initial access flow, the service provider can access a website 1002 having a user interface 1004. The service provider can proceed to a registration operation 1006. At operation 1006, the service provider can create an account, provide contact information, and so forth. At operation 1008, the service provider can establish billing. For example, the platform can charge the service provider a fee to have the service provider's offerings available on the platform. In some implementations, the platform can collect payment from users and provide payments to the service provider whenever a user uses the service provider's services. At operation 1010, the platform and service provider can arrange for API access. At operation 1012, the service provider and platform can arrange for access to content. At operation 1014, the service provider can configure partnership settings. The partnership settings can include, for example, revenue sharing schemes, costs to users for using the service provider, limits on content, prompts, etc., provided to the service provider and/or limitations on content generated by the service provider, restrictions on regions that have access to the service provider, and so forth. The service provider can then be directed to a dashboard 1016. The dashboard 1016 can include functionality that allows the service provider to view usage, view or modify settings, update billing information, and so forth. The dashboard can access information about licensed content and models 1018.

A service provider that is established with the platform can access the platform via the website 1002 (e.g., to access the dashboard 1016) or via an API 1020.

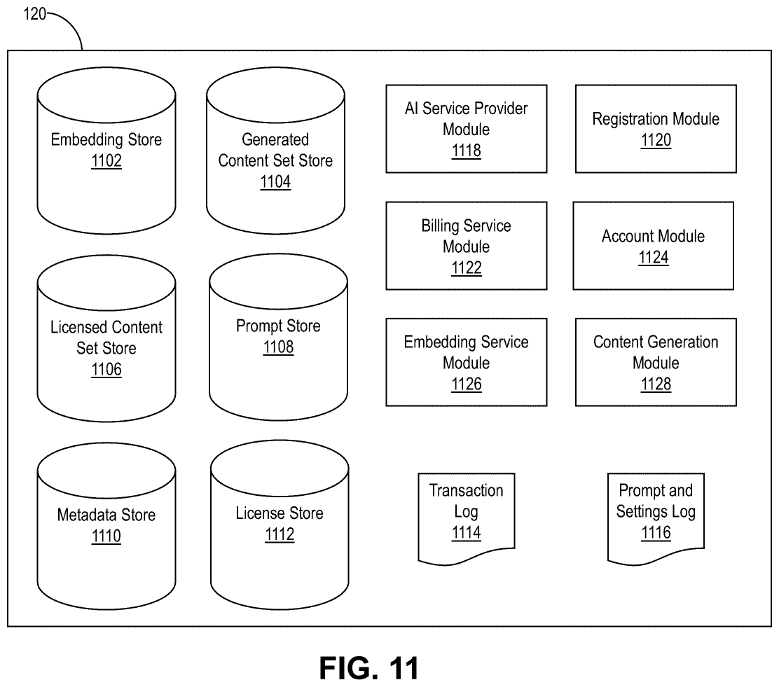

FIG. 11 is a block diagram that illustrates an example generation system 120 according to some implementations. The generation system 120 can include various components, such as an embedding store 1102, generated asset collection store 1104, licensed asset collection store 1106, prompt store 1108, metadata store 1110, and license store 1112. The generation system 120 can include a transaction log 1114 and a prompt and settings log 1116. The generation system 120 can include an AI service provider module 1118, a registration module 1120, a billing service module 1122, an account module 1124, an embedding service module 1126, and a content generation module 1128.

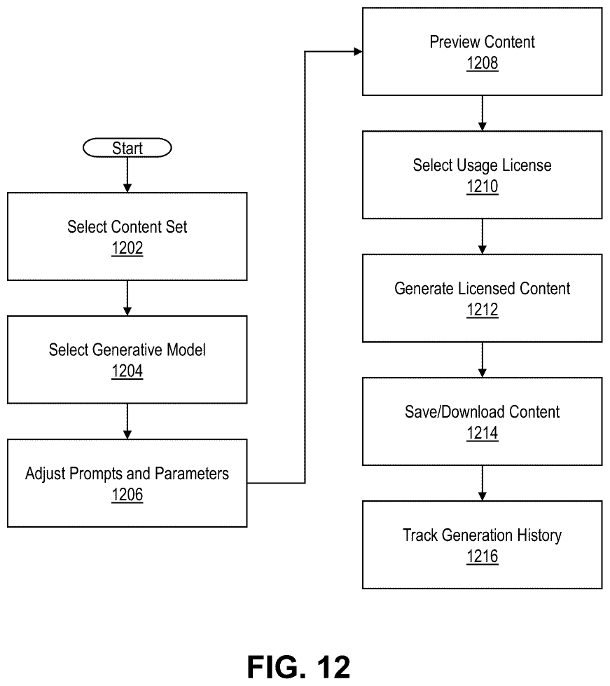

FIG. 12 is a flowchart that illustrates an example process for generating content. At operation 1202, an end user can select one or more asset collections. The generated content can be based on the assets in the asset collection. At operation 1204, the creator can select a generative model to use to generate assets. At operation 1206, the creator can adjust a prompt and/or one or more parameters for generating an asset. At operation 1208, the platform can provide the user with a preview of the content. The preview can have various limitations. For example, the preview can be provided in low resolution, with watermarks, and so forth, such that the preview is not suitable for use. This can enable the creator to determine if they wish to proceed with generating an asset without the creator being able to easily generate usable assets without making payment and licensing content. In some implementations, operations 1206 and 1208 can be repeated (e.g., at creator request) until they wish to proceed with asset generation. At operation 1210, the creator can select a usage license. For example, the user can indicate if the generated asset is for commercial use, regions in which the generated asset will be used, an amount of time the generated asset will be used, and so forth. At operation 1212, the platform can generate licensed content for the creator. At operation 1214, the platform can provide the generated content to the creator, for example by saving it to storage associated with the user or providing the user with a link to download the generated asset. In some implementations, for example when an end user utilizes a plugin or extension to an application, the generated asset can be inserted into a file open within the application. For example, a generated asset can be inserted automatically as a new layer of an image in an image editing application. At operation 1216, the platform can log the generation. The log can store, for example, the generated asset or a representation of the generated asset (e.g., extracted metadata, generated embeddings, etc.), a time when the asset was generated, license terms associated with the generated asset, payment terms associated with the generated asset, and so forth.

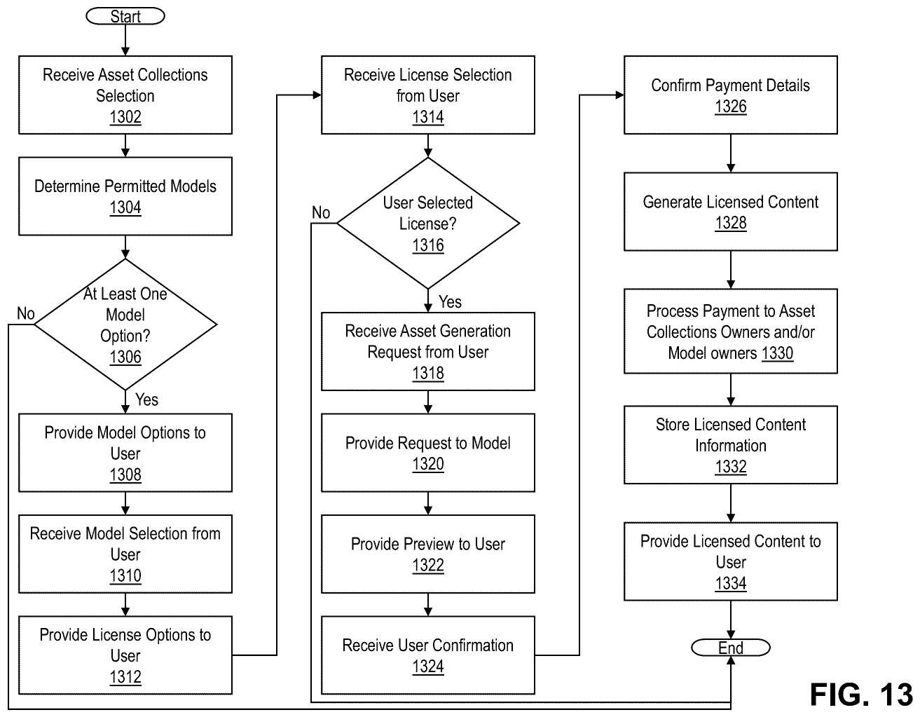

FIG. 13 is a block diagram that illustrates a process flow for generating assets according to some implementations. At operation 1302, a platform can receive a selection of one or more asset collections from a user. The one or more asset collections can be asset collections on which the user wants to base generated assets. For example, the one or more asset collections can include asset collections for a particular brand, movie, cartoon, advertising agency, etc. At operation 1304, the platform can determine, based on the selected one or more asset collections, one or more permitted models. For example, as described herein, different asset collections can have different licensing terms, restrictions, etc., imposed thereon. The restrictions can permit some models and/or disallow some models. If the user has selected only one asset collection, the permitted models can be the models allowed for that asset collection. If the user has selected more than one asset collection, the platform can determine a common set of allowed models. For example, each asset collection can have associated therewith a set of one or more permitted models, and the platform can determine the intersection of the permitted models for the one or more asset collections. At operation 1306, if there are no permitted models (e.g., the intersection of permitted models for the selected asset collections is an empty set), the platform can provide a notification that there are no available models and the process can end. In some cases, the user may update their selection, for example to remove one or more asset collections and/or to select different asset collections. If there is at least one permitted model, the process can continue. At operation 1308, the platform can provide the at least one model option to the user. At operation 1310, the platform can receive a selection of a model from the user. Alternatively or additionally, the platform can automatically select a model from among the permitted models, for example based on cost of the model or performance of the model for types of assets in the asset collection. At operation 1312, the platform can provide license options to the user. In the case of multiple asset collections, license options can be presented for each asset collection. At operation 1314, the user can select a license or multiple licenses (e.g., one license for each asset collection). In some implementations, the platform can be configured to identify licensing conflicts. For example, if a user selects a first license for a first asset collection that allows usage in a first region only and selects a second license for a second asset collection that allows use in a second, different, region only, the platform can provide an indication to the user that the licenses conflict. In some cases, the user may update their license selection. In some implementations, the platform can be configured to bundle licenses for different asset collections, such that the user can only select licenses that are compatible with one another. In some implementations, the platform can determine a most restrictive set of licensing terms based on the available licenses for the selected asset collections and can show the most restrictive terms to the user. For example, if a first license allows use in the United States, Canada, and Mexico, and a second license allows use in the United States, Canada, and the European Union, the platform can determine that in order to comply with both licenses, the generated assets can only be used in the United States and Canada. At operation 1316, the platform can determine if the user selected a license (or a plurality of licenses). If not, for example because the user did not find any licenses acceptable, the process can end. If the user has selected one or more licenses, the process can continue.

At operation 1318, the platform can receive an asset generation request from a user. For example, the user can provide an input that describes the type of generated asset the user wishes to produce. In some implementations, the platform can perform one or more checks against one or more moderation rules prior to continuing. For example, if rightsholders have indicated that their assets cannot be used to generate violent imagery and the request includes a request to generate violent imagery, the platform can reject the request and, for example, display an alert to the user. At operation 1320, the platform can provide the request to a model, such as the model selected at operation 1310. In some cases, the model can be hosted by the platform. In some cases, the model can be hosted by a model owner or other party, and the platform can communicate with the model via an API to send and receive information related to the request. At operation 1322, the platform can provide a preview of the generated asset to the user. At operation 1324, the platform can receive confirmation from the user that the user wishes to proceed with generating content. At operation 1326, the platform can confirm payment details. For example, the platform can provide the user with a notification of the cost of generated assets, a summary of license terms of the generated assets, and so forth, and can receive confirmation from the user that the user wishes to continue. At operation 1328, the platform can generate the licensed content, for example using a generative model hosted by the platform or by communicating with a generative model owner. At operation 1330, the platform can process payment to the asset collections owners and/or the model owners, for example by communicating with a third party payment service. At operation 1332, the platform can store information about the licensed content, such as the license terms, a quality score associated with the generated asset, etc. At operation 1334, the platform can provide the licensed content to the user. In some implementations, the platform can provide the user with an option to allow license of the generated content. In some implementations, the platform can be configured to provide fractional payments to the rightsholders whose assets were used to create the licensed content.

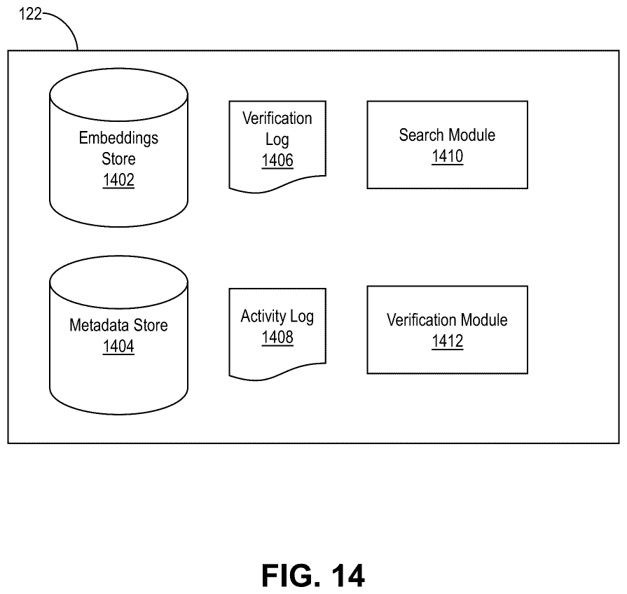

FIG. 14 is a block diagram that illustrates various components of a verification system according to some implementations. The verification system 122 can include an embeddings store 1402 and a metadata store 1404. The verification system 122 can include a verification log 1406 and an activity log 1408. The verification system 122 can include a search module 1410 and a verification module 1412. The search module 1410 and the verification module 1412 can be used, for example, to identify potentially unauthorized generated content, to detect duplicates, to detect when someone submits content for which they do not own the rights, and so forth.

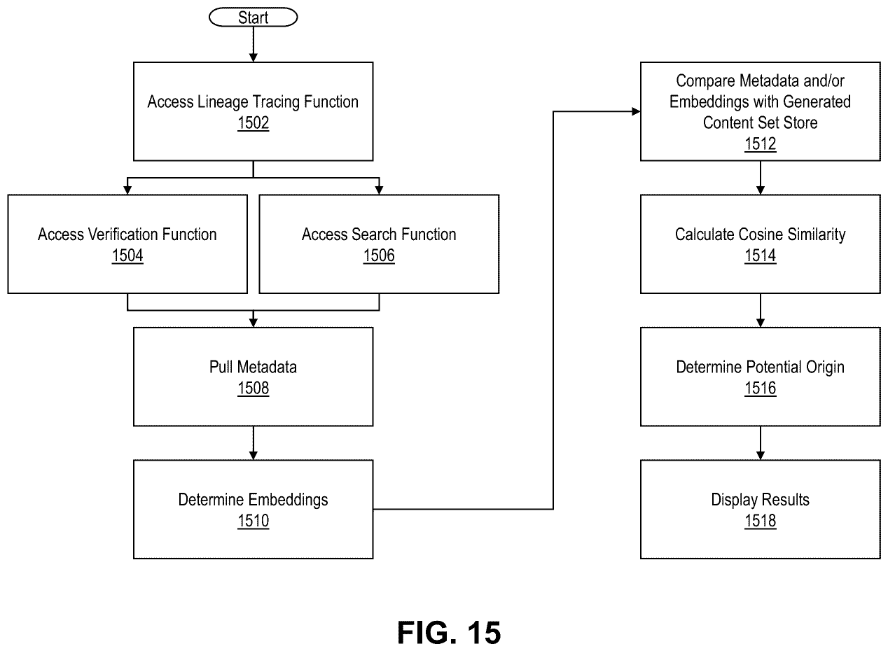

The platform can also offer functionality for tracing the lineage of content. For example, a rightsholder may want to see if a generated asset was generated based on the rightsholder's assets. Lineage tracing can be used for determining which generated assets were based on which other assets, for example for purposes of enforcing licensing terms, securing payment, and so forth. FIG. 15 illustrates an example process for origin tracking according to some implementations. At operation 1502, a rightsholder can access an origin tracking function provided by the platform. The origin tracking process can proceed in a number of ways. In some cases, a rightsholder may have a suspect asset for which they wish to trace the origin. In some cases, a rightsholder may have original content that the rightsholder owns and may wish to check to see if assets have been generated based on the original content. At operation 1504, the rightsholder can access a verification function. In this flow, the rightsholder can provide a suspect asset to the platform, and the platform can determine one or more other assets used to generate the suspect assets. Alternatively or additionally, at operation 1506, the rightsholder can access a search function. In this flow, the rightsholder can provide their content and search for generated assets that may have been based on the content. At operation 1508, the platform can pull metadata and, at operation 1510, the platform can extract embeddings (e.g., embeddings of a suspect asset or embeddings of content provided by the rightsholder). At operation 1512, the platform can compare the metadata and embeddings with content in a generated asset collection store. At operation 1514, the platform can compute cosine similarities and/or other metrics to determine if assets are related to one another. At operation 1516, the platform can use the compared metadata, compared embeddings, and/or calculated cosine similarities to determine a potential origin of one of more assets. At operation 1518, the platform can provide the results to the rightsholder. For example, if the rightsholder submitted a suspect asset, the platform can display a result indicating whether or not the suspect asset is based on the rightsholder's assets. If the rightsholder submitted their own content, the results can include zero or more assets that may have been generated from the rightsholder's content. In some implementations, the platform may provide a binary answer (e.g., a yes or no answer as to whether or not a suspect asset is based on the rightsholder's assets). In some implementations, the platform may, alternatively or additionally, provide a confidence level or similarity percentage.

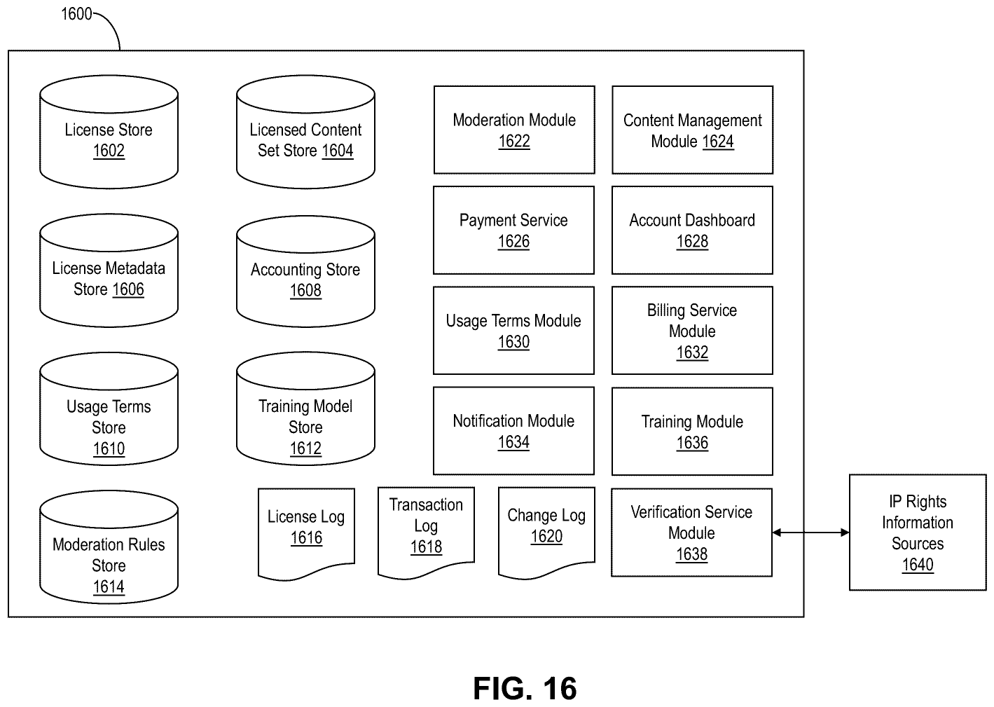

FIG. 16 illustrates a high level block diagram of various components of a license system 1600. The license system can include a license store 1602, licensed asset collection store 1604, license metadata store 1606, accounting store 1608, usage terms store 1610, training model store 1612, and moderation rules store 1614. The license system 1600 can include a moderation module 1622, content management module 1624, payment service module 1626, account dashboard 1628, usage terms module 1630, billing service module 1632, notification module 1634, and training module 1636. The license system 1600 can store a license log 1616, transaction log 1618, and change log 1620.

In some implementations, the license system 1600 can include a verification service module 1638. In some implementations, the verification service module 1638 can communicate with one or more IP rights information sources 1640. The one or more IP rights information sources 1640 can include, for example, national and/or state intellectual property offices, IP rights management organizations, and so forth. For example, the verification service module 1638 can submit a query to determine who the rightsholder is for an asset and can receive responses from the one or more IP rights information sources 1640 indicating rightsholder information or indicating that no rightsholder information was found. In some implementations, the verification service module 1638 can implement additional functionality, such as registering a generated asset with an IP rights information source.

While various modules, stores, and logs are depicted in FIG. 16, it will be appreciated that different implementations of the platform can include fewer, additional, and/or different modules, stores, and/or logs, depending upon the specific implementation. In some implementations, modules, stores, and/or logs can be combined with other modules, stores, and/or logs.

It is expected that those who license models, assets, and so forth for use on the platform may change their usage terms, models, content, payment terms, and so forth over time. Thus, it can be significant to maintain accurate logs of usage, applicable licensing terms, and so forth.

In some implementations, logs can be stored in a database. In some implementations, logs can be stored on a blockchain. For example, in some implementations, logs can be committed to a blockchain on a regular schedule, such as after each transaction on the platform, daily, weekly, and so forth. In some implementations, all activity for all users on the platform can be rolled up and committed to a blockchain on a regular basis, for example daily. In some implementations, the activity for each user of the platform can be rolled up and committed to the blockchain on a regular basis, for example daily. Such an approach can be significant because, for example, it can limit computational resources required to maintain the blockchain while providing each user of the platform with an accurate log of their activity on the platform.

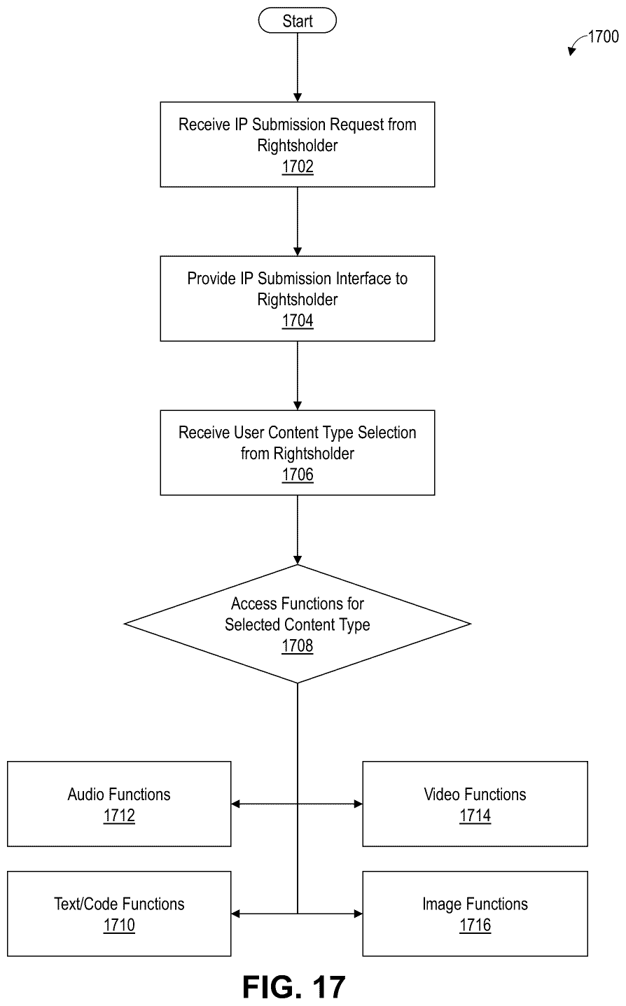

FIG. 17 is a flowchart that illustrates an example process for accessing functions for various content types according to some implementations. The process 1700 can be carried out on a computer system. At operation 1702, the system can receive an IP submission request from a rightsholder. For example, the rightsholder can click a button or other user interface element in a web page, application, etc., can submit content via an application or web page, and so forth. At operation 1704, the system can provide an IP submission interface to the rightsholder. The IP submission interface can provide an input for the rightsholder to specify a content type of the IP the rightsholder is submitting. In some implementations, rightsholders can select multiple content types. At operation 1706, the system can receive a content type selection. In some implementations, rather than the rightsholder selecting a content type, the rightsholder can upload or otherwise provide access to the content the rightsholder wants to submit, and the system can analyze the content (e.g., metadata of the content) to determine one or more content types.

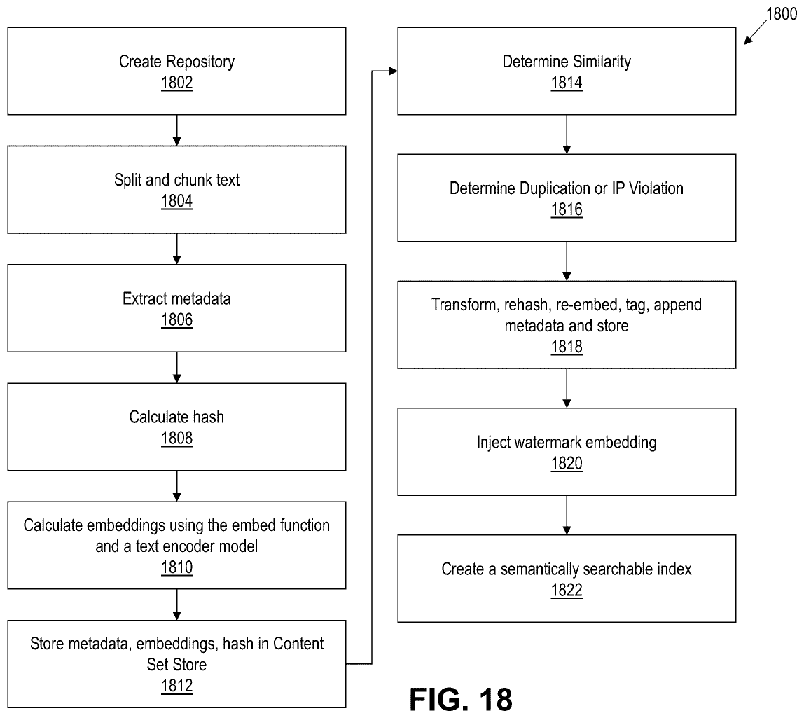

At operation 1708, the system can determine different functions to access for different content types. In some implementations, functions can include text/code functions 1710, audio functions 1712, video functions 1714, and image functions 1716. Other functions can be provided additionally or alternatively. The system can provide type-specific processing for each of these types of functions, as described in more detail with respect to FIGS. 18-9. It will be appreciated that, in some implementations, multiple types of functions may be accessed. For example, if a user submits video content, the video functions can be accessed. In some cases, audio functions may also be accessed, for example to carry out operations related to the audio track of the video. Image functions may be used to carry out operations related to image frames in the video. In some implementations, text/code functions can be accessed, for example to carry out operations relating to text-based information in the video, such as closed captions.

While described in relation to IP submissions, it will be appreciated that the process described with respect to FIG. 17, as well as the processes described below with respect to FIGS. 18-21, can be applied in other contexts, such as when an asset is submitted for lineage tracking.

FIG. 18 is a block diagram that illustrates an example process for processing text/code submissions according to some implementations. The process 1800 can be executed by a computer system. At operation 1802, the system can create a repository for a submission. The submission can include one or more files. At operation 1804, the system can split and chunk text in the files. Chunking can be performed in various ways. For example, in some implementations, text is split into chunks by pages, based on section headings, chapter headings, subheadings, etc. In some implementations, for example, in the case of source code, chunking is performed based on the start and stop of functions, methods, objects, etc. In some implementations, chunking can be performed by dividing text into a particular number of tokens. There can be a token overlap between chunks, which can be significant for maintaining context. The overlap can comprise tens, hundreds, or thousands of tokens, or more or less. For example, in some implementations, token overlap between two chunks comprises from 1800 or about 1800 tokens to 2000 or about 2000 tokens. In some implementations, text is chunked without preprocessing. In some implementations, the platform is configured to perform various cleaning operations, such as removing line breaks, white space, etc. In some implementations, cleaning can include removing certain words, such as articles. In some implementations, textual information is processed by converting text to one or more graphical representations and using computer vision models to analyze the graphical representations.

At operation 1806, the system can extract metadata included in the files. At operation 1808, the system can calculate a hash for each file in the submission. At operation 1810, the system can calculate embeddings for each file in the submission, for example using an embedding function and/or a text encoder model. In some implementations, the system calculates an embedding for each chunk. At operation 1812, the system can store the metadata, the embeddings, and the hashes in a content set store. At operation 1814, the system can determine similarity (e.g., cosine similarity) between the submitted files and other files that have previously been submitted or analyzed, which in some implementations can include files obtained from external sources, such as scraped from the internet. At operation 1816, the system can, based on the determined similarity, the metadata, and/or the hashes, determine if there is a duplication or IP violation. At operation 1818, the system can perform one or more of transforming, rehashing, re-embedding, tagging, and/or appending metadata to a file, and can store the resulting file and/or any information relating to the file in a content store. At operation 1820, the system can inject watermarks into the embeddings. At operation 1822, the system can create a searchable index of the repository, for example a semantically searchable index.

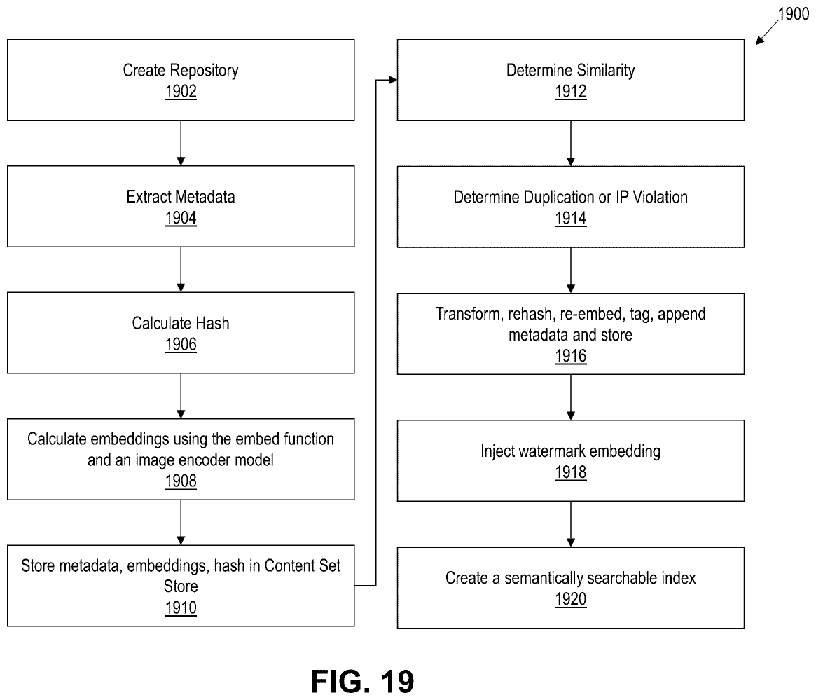

FIG. 19 is a block diagram that illustrates an example process for processing image submissions according to some implementations. The process 1900 can be executed by a computer system. At operation 1902, the system can create a repository for a submission. The submission can include one or more image files. At operation 1904, the system can extract metadata from the image files. At operation 1906, the system can calculate hashes for each image file. At operation 1908, the system can calculate embeddings, for example using an embedding function and/or an image encoder model. At operation 1910, the system can store the metadata, the embeddings, and the hashes in a content set store. At operation 1912, the system can calculate similarity (e.g., cosine similarity) between the submitted images and previously submitted and/or analyzed images. At operation 1914, the system can, based on the determined similarity, metadata, and/or hashes, determine if there is a duplication or IP violation. At operation 1916, the system can transform, rehash, re-embed, tag, append metadata, and/or otherwise manipulate the images and can store the results. At operation 1918, the system can inject a watermark embedding. At operation 1920, the system can create a searchable index, e.g., a semantically searchable index, of the submitted images.

In some implementations, image submissions undergo various preprocessing steps. For example, a rightsholder can upload images that include a foreground and background (e.g., one or more characters present in front of a background or on a set). In some implementations, an imagine may include one or more objects. A rightsholder may wish to create a content set that includes only foreground content (e.g., only characters), a content set that includes only background content (e.g., sets, scenes, etc.), a content set that includes only objects, or multiple content sets, such as one content set for foreground content and one content set for background content.

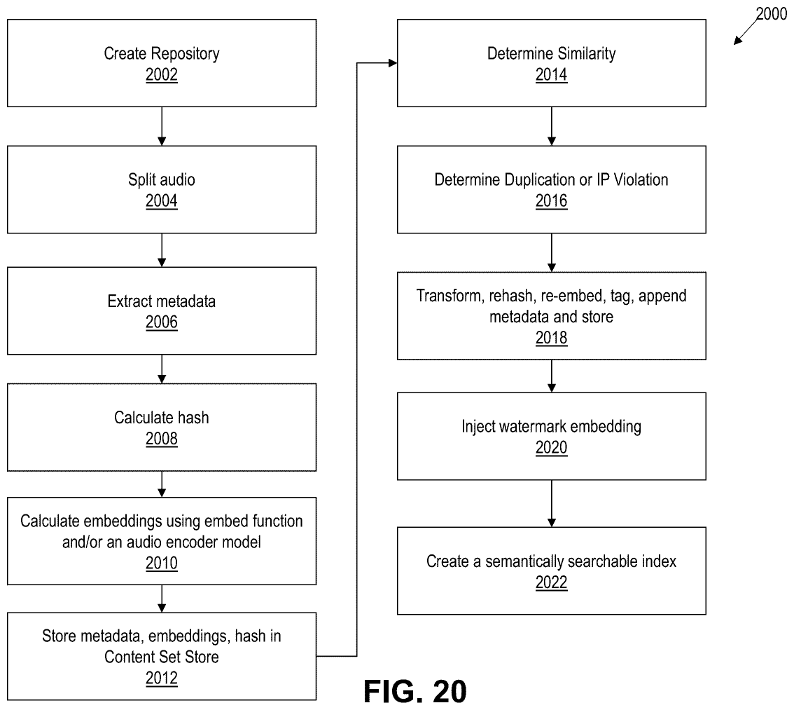

FIG. 20 is a block diagram that illustrates an example process for processing audio submissions according to some implementations. The process 2000 can be executed by a computer system. At operation 2002, the system can create a repository for a submission. At operation 2004, the system can split the received audio files in the submission. The system can use a split function to split the audio of each audio file into one or more spectrogram images that visually represent a relationship between time and frequency components within the audio. Furthermore, if a received audio file contains a lyrics component, the lyrics can be split from the audio components and can be processed as text, for example by the process illustrated in FIG. 18, while the audio component continues processing in FIG. 20. At operation 2006, the system can extract metadata from the audio files. At operation 2008, the system can calculate a hash for each audio file. At operation 2010, the system can calculate embeddings for the audio files, for example using an embedding function and/or an audio encoder model. For example, some implementations of the system can generate image embeddings from a spectrogram that visually represents the audio of the audio file. In other implementations, the system generates one or more audio fingerprints that provide a unique digital representation of a respective portion of the audio file. At operation 2012, the system can store the metadata, the embeddings, and the hashes in a content set store. At operation 2014, the system can determine similarity (e.g., cosine similarity) between the submitted audio files and previously submitted and/or analyzed audio files. At operation 2016, the system can, based on the determined similarity, the hashes, and/or the metadata, determine whether there is a duplication or IP violation. At operation 2018, the system can transform the files, rehash, re-embed, append metadata, and store the results. At operation 2020, the system can inject watermarks into the embeddings, such as a wavmark embedding, to enable identification of synthetic data. At operation 2022, the system can generate a searchable index (e.g., a semantically searchable index) of the submitted audio files. For example, a user can search for music in a particular genre, a particular type of spoken word (e.g., fiction or non-fiction, horror, thriller, true crime, fantasy, sci-fi, etc.), audio files of a minimum or maximum length, and so forth.

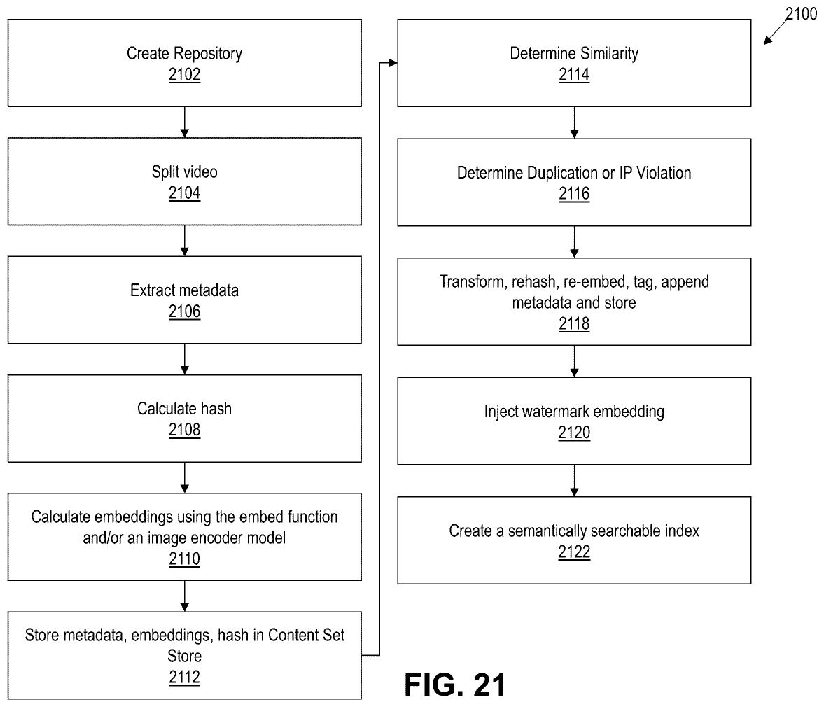

FIG. 21 is a block diagram that illustrates an example process for processing video submissions according to some implementations. The process 2100 can be executed by a computer system. At operation 2102, the system can create a repository for the video submission. At operation 2104, the system can split the received one or more videos. A video can be split into image components and audio components, with these components processed separately according to the various processes described herein. In some implementations, text (e.g., captions, lyrics, etc.), can be split and processed separately according to the various processing described herein. At operation 2106, the system can extract metadata from the videos. At operation 2108, the system can calculate hashes for each video. At operation 2110, the system can calculate embeddings for each video, for example using an embedding function and/or an image encoder model. In some implementations, embeddings are calculated based on one or more frames extracted from a video. At operation 2112, the system can store the metadata, the embeddings, and the hashes in a content set store. At operation 2114, the system can determine a similarity between the videos and previously submitted and/or analyzed videos, for example by calculating cosine similarity. At operation 2116, the system can, based at least in part on the determined similarity, the hashes, and/or the metadata, identify duplications and/or IP violations. At operation 2118, the system can transform the files, rehash, re-embed, tag, and/or append metadata, and store the results. At operation 2120, the system can inject a watermark embedding into the videos. At operation 2122, the system can create a searchable index of the submitted videos, for example a semantically searchable index.

As described herein, in some cases, images, audio, text, etc., can be extracted from a video file, in which case the extracted data can be fed into an appropriate process for the type of data extracted.

In some implementations, a platform divides video into frames, collections of frames (e.g., scenes), etc. In some implementations, video can be processed without separating out various components such as audio data and image data. In some implementations, video can be split based on time (e.g., chunked into segments with a fixed length), scene changes, characters present, etc. In some implementations, video can be preprocessed. For example, a user can upload a video and choose to extract only certain content for creating a content set. For example, a user may want to create a content set from a video that includes only scenes or images with a specific character or characters, which includes only specific backgrounds, etc. Computer vision methods and/or machine learning models can be used to identify characters, backgrounds, etc., in video, thereby enabling automatic splitting of videos and/or creation of content sets.

The approaches herein can also be used for other types of content, such as 3D content, video games, and so forth. In some implementations, the platform receives a submission comprising 3D content. 3D file types can include, for example and without limitation, OBJ, FBX, STL, AMF, IGES, gITF, USD, UDSZ, IPT, IAM, SLD, JT, BLEND, SBSAR, STL, DAE, 3DS, U3D, KMZ, etc. Different file formats can support different features, and can be processed differently, though there can generally be similarity in how 3D files are processed. Depending upon the specific file type, different information can be processed. For example, OBJ files can support units (e.g., centimeters, inches, feet, etc.), multiple objects, etc. FBX files can include additional information, such as full 3D scenes including cameras, lighting, geometry, skeletal structure for animation, etc. Some 3D files can be commonly used for rendering 3D objects, for video games, for animation, for CAD, etc. Some 3D files can be used for 3D printing. For example, AMF and STL files are commonly used for 3D printing.

In some implementations, metadata can be extracted from 3D files and/or associated with the 3D files. Metadata can include, for example, copyright information, license type, creation date, creator name, object ID, keywords, tags, file format, scale, contact information, attribution requirements, modification rights, distribution history, generative prompt history, and/or the like. Copyright information can identify the copyright holder of the 3D file. License type can specify the type or types of licenses available, content restrictions, etc. For example, the license type can indicate if a 3D file is rights-managed, royalty-free, etc. Creation date can indicate a date when the file was initially created. Creator name can indicate the name of an individual or organization who created the 3D file. Object ID can be a unique identifier that can be used for tracking the 3D file within a database or system. Keywords, tags, or both can be used for organizing and/or searching content on a platform. Modification rights can indicate whether or not the 3D file can be modified and, if so, under what circumstances (e.g., limitations on what modifications can be carried out, any attribution requirements, etc.). Distribution history can store information about past distribution of the 3D file. Generative prompt history can include information about whether or not generative AI models have been used, any prompts used, etc.

In some implementations, the platform provides received 3D files to a machine learning model, which can be configured to output a text-based summary of the content of the 3D files, such as objects depicted into the files, textures used in the files, camera positions and/or number of cameras (if defined in the file), lighting positions and/or number of lights (if defined in the file), etc. In some implementations, the platform provides the summaries in a searchable manner, such that an end user can search for a type of 3D file they are looking for and receive appropriate results. For example, if a user searches for “animatable dog,” the platform can return results that include models for dogs and in which skeletal structures appropriate for animation are defined.

In some implementations, the platform can apply a watermark to a 3D file. Watermarking can be done in various manners including, for example and without limitation, spatial domain techniques such as vertex displacement, voxel-based methods, and so forth, spectral domain techniques such as frequency domain and Fourier domain embedding, or transform domain techniques such as wavelet-based embedding.

The techniques herein can be applied to video games in some implementations. Video games can generally be handled by the platform in a manner similar to those described herein for other types of content. A video game can include audio, 3D models, executable code, images, video, text (e.g., captions, written text displayed to the user, etc.) and so forth. These different types of content can be processed by the platform, for example as described herein. In some implementations, the platform is configured to generate embeddings based on user interactions, user interfaces, etc., of a video game.

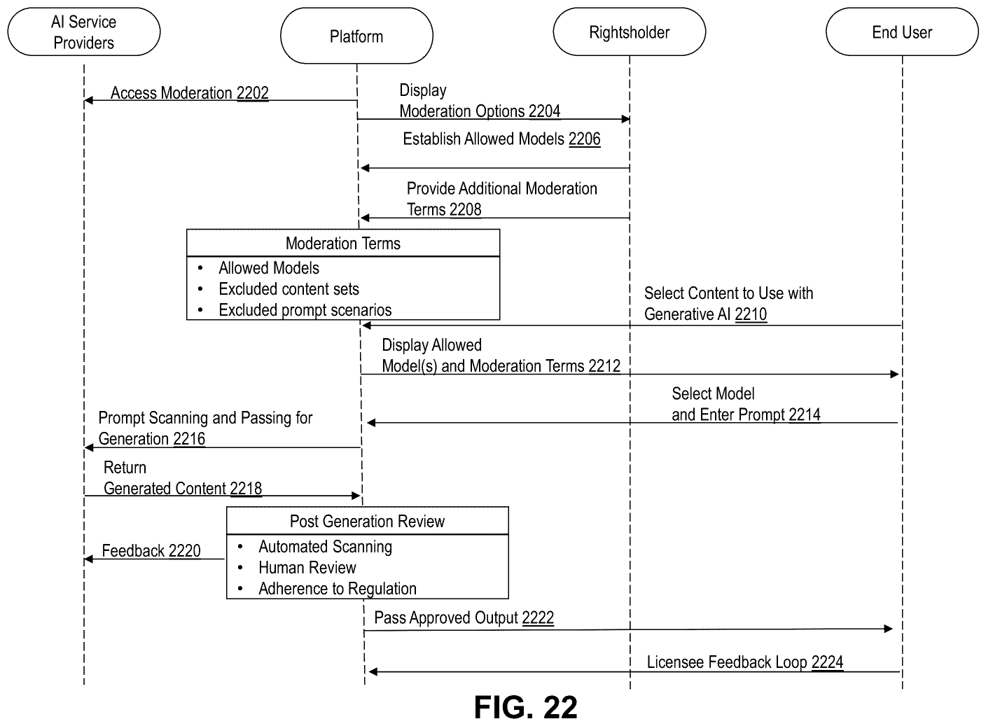

FIG. 22 is a diagram that illustrates interactions involved in a licensing process according to some implementations. At operation 2202, a platform can access moderation policies from one or more generative AI service providers. At operation 2204, the platform can make these policies available to a rightsholder. The rightsholder can review the policy and, at operation 2206, can provide an indication of allowed models to the platform. For example, the rightsholder can select one or more permitted models for use with the rightsholder's content. At operation 2208, the content creator can provide additional moderation terms to the platform. Moderation terms can include, for example, allowed models, excluded content sets, excluded prompt scenarios, and so forth. In some implementations, the rightsholder can specify that the content set cannot be used with one or more other content sets. At operation 2210, an end user (licensee) can select content to use for generative AI and can inform the platform of the selection. At operation 2212, the platform can determine allowed model(s) and moderation terms, and can present the allowed model(s) and moderation terms to the licensee. At operation 2214, the licensee can select a model and provide a prompt to the platform. At operation 2216, the platform can scan the prompt and, if there are no issues (e.g., an excluded prompt scenario) identified, can pass the prompt to an AI service provider for generation. In some implementations, a prompt can be escalated for human review, for example if the platform is unable to make a determination of whether or not the prompt violates a moderation rule. At operation 2218, the AI service provider can return generated content to the platform. At operation 2220, the platform can perform a post-generation review, for example using automated scanning and/or human review. In some implementations, the post-generation review can include checking for adherence to one or more regulations, moderation rules, etc. The platform can provide feedback regarding the post-generation review to the AI service provider. At operation 2222, the platform can pass approved generated content to the licensee. At operation 2224, the licensee can provide feedback to the platform, for example feedback about the quality of the generated content. In some implementations, such feedback can be provided to the AI service provider, who may use the feedback to improve their offerings.

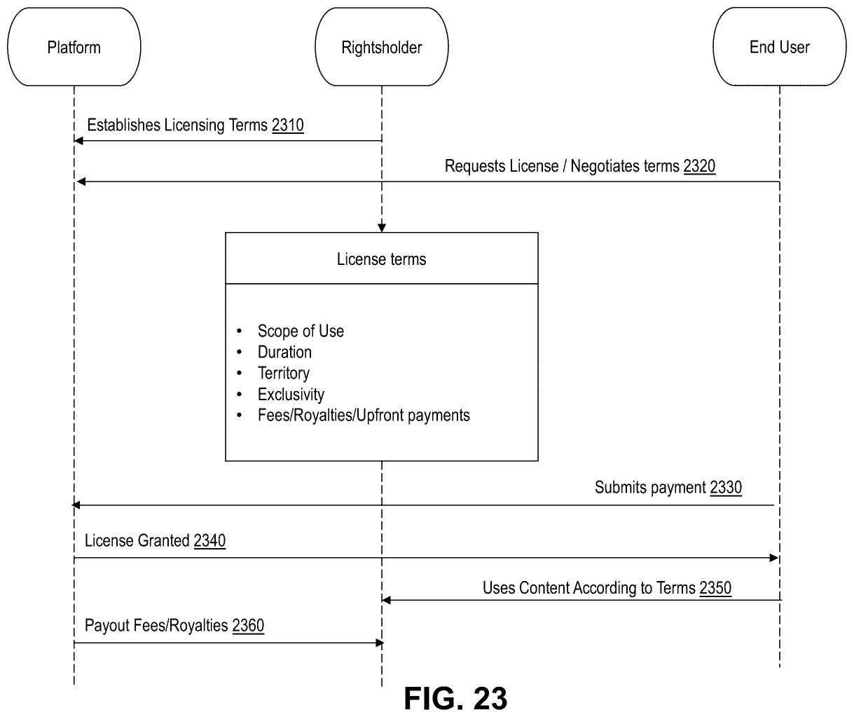

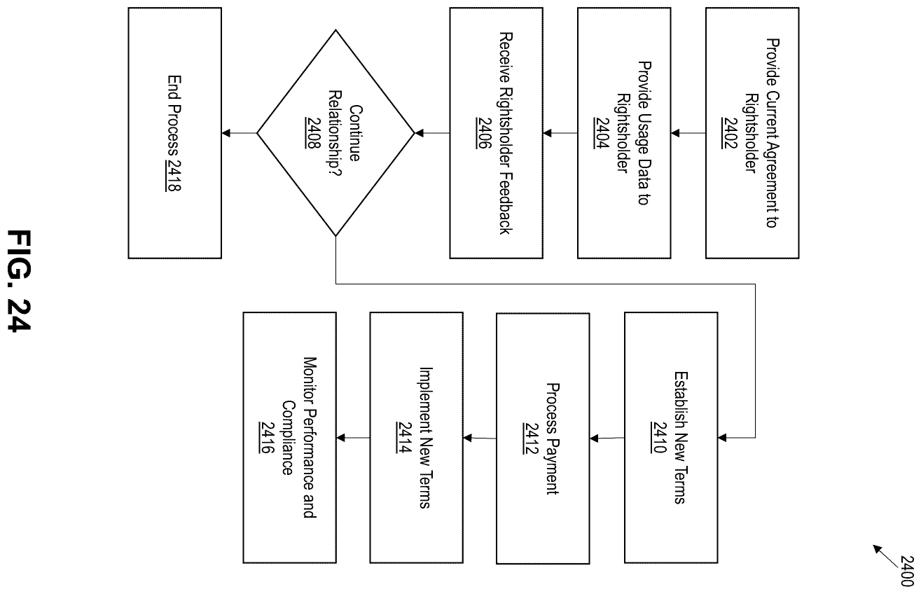

FIG. 23 is a diagram that illustrates an example licensing flow according to some implementations. At operation 2310, a rightsholder can establish licensing terms with a platform. The license terms can include, for example, scope of use, duration, territory, exclusivity, fees, royalties, upfront payments, and so forth. At operation 2320, a licensee can request a license and/or negotiate license terms. At operation 2330, after agreeing to license terms, the licensee can submit payment to the platform in accordance with the license terms. At operation 2340, the platform can grant the license to the licensee. At operation 2350, the licensee can use the licensed content according to the license terms. At operation 2360, the platform can pay out fees, royalties, and/or the like to the content creator.

FIG. 24 is a diagram that illustrates an example license renewal process according to some implementations. The process 2400 can be performed by a computer system. At operation 2402, the system can provide a current license agreement to the rightsholder. At operation 2404, the system can provide usage data to the rightsholder. At operation 2406, the system can receive feedback from the rightsholder. At operation 2408, the rightsholder can indicate whether or not they would like to continue the relationship with the licensee. If not, the process can end at operation 2418, in which case the current agreement can be allowed to expire. If so, at operation 2410, the system can facilitate the establishment of new terms between the rightsholder and the licensee. At operation 2412, the system can process payment from the licensee. At operation 2414, the system can implement the new terms. In some cases, the new terms may be implemented in a delayed manner, for example upon the expiration of the current agreement. At operation 2416, the system can monitor performance and compliance with the new terms.

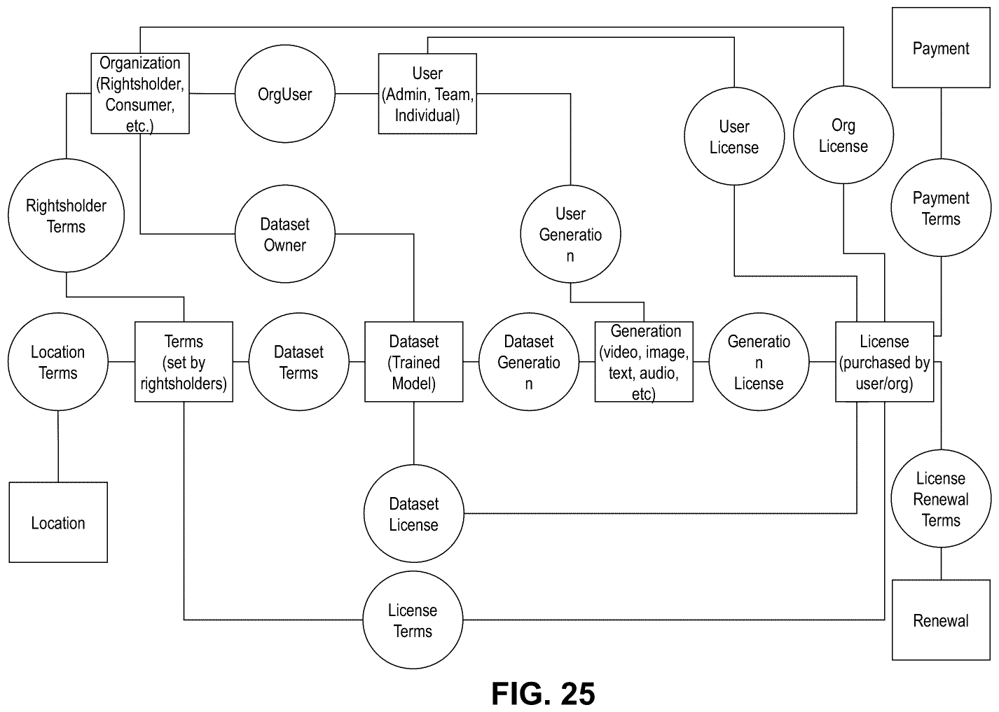

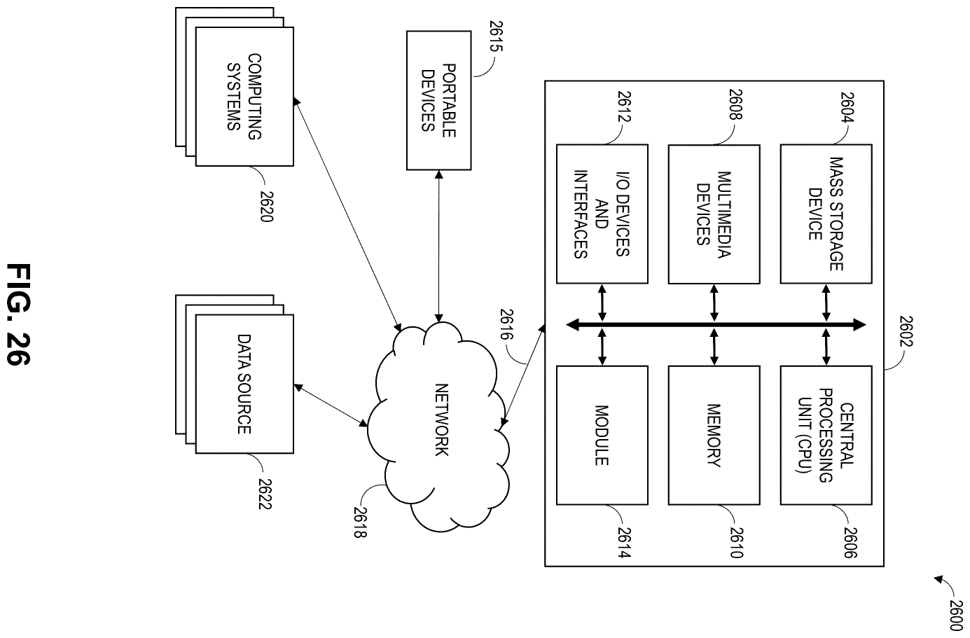

FIG. 25 is a block diagram that illustrates various components of a platform and various actors and actions that can utilize the platform according to some implementations.

### Computer System

FIG. 26 is a block diagram 2600 depicting an implementation of a computer hardware system 2602 configured to run software for implementing one or more of the systems and methods described herein. The example computer system 2602 is in communication with one or more computing systems 2620 and/or one or more data sources 2622 (which can include, for example, filesystems, databases, network shares, etc.) via a network 2618. In some implementations, the computer system 2602 can be in communication via a plurality of networks. While FIG. 26 illustrates an implementation of a computing system 2602, it is recognized that the functionality provided for in the components and modules of computer system 2602 may be combined into fewer components and modules, or further separated into additional components and modules.

The computer system 2602 can comprise a module 2614 that carries out the functions, methods, acts, and/or processes described herein. The module 2614 is executed on the computer system 2602 by a central processing unit 2606 discussed further below.

In general, the word “module,” as used herein, refers to logic embodied in hardware or firmware or to a collection of software instructions, having entry and exit points. Modules are written in a program language, such as Java, C or C++, Python, or the like. Software modules may be compiled or linked into an executable program, installed in a dynamic link library, or may be written in an interpreted language such as BASIC, PERL, Lua, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within special designed hardware or firmware. Not all calculations, analysis, and/or optimization require the use of computer systems, though any of the above-described methods, calculations, processes, or analyses may be facilitated through the use of computers. Further, in some implementations, process blocks described herein may be altered, rearranged, combined, and/or omitted.

The computer system 2602 includes at least one central processing unit (CPU) 2606, which may comprise a microprocessor, field programmable gate array, etc. The computer system 2602 further includes a physical memory 2610, such as random-access memory (RAM) for temporary storage of information, a read only memory (ROM) for permanent storage of information, and a mass storage device 2604, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system 2602 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 2602 includes one or more input/output (I/O) devices and interfaces 2612, such as a keyboard, mouse, touch pad, and printer. The I/O devices and interfaces 2612 can include one or more display devices, such as a monitor, which allows the visual presentation of data to a user. More particularly, a display device provides for the presentation of GUIs as application software data, and multi-media presentations, for example. The I/O devices and interfaces 2612 can also provide a communications interface to various external devices. The computer system 2602 may comprise one or more multi-media devices 2608, such as speakers, video cards, graphics accelerators, and microphones, for example.

The computer system 2602 may run on a variety of computing devices, such as a server, a Windows server, a Structure Query Language server, a Unix Server, a personal computer, a laptop computer, and so forth. In other implementations, the computer system 2602 may run on a cluster computer system, a mainframe computer system and/or other computing system suitable for controlling and/or communicating with large databases, performing high volume transaction processing, and generating reports from large databases. The computing system 2602 is generally controlled and coordinated by an operating system software, such as z/OS, Windows, Linux, UNIX, BSD, SunOS, Solaris, MacOS, or other compatible operating systems, including proprietary operating systems. Operating systems control and schedule computer processes for execution, perform memory management, provide file system, networking, and I/O services, and provide a user interface, such as a graphical user interface (GUI), among other things.

The computer system 2602 illustrated in FIG. 26 is coupled to a network 2618, such as a LAN, WAN, or the Internet via a communication link 2616 (wired, wireless, or a combination thereof). Network 2618 communicates with various computing devices and/or other electronic devices, such as portable devices 2615. Network 2618 is communicating with one or more computing systems 2620 and one or more data sources 2622. The module 2614 may access or may be accessed by computing systems 2620 and/or data sources 2622 through a web-enabled user access point. Connections may be a direct physical connection, a virtual connection, and other connection type. The web-enabled user access point may comprise a browser module that uses text, graphics, audio, video, and other media to present data and to allow interaction with data via the network 2618.

Access to the module 2614 of the computer system 2602 by computing systems 2620 and/or by data sources 2622 may be through a web-enabled user access point such as the computing systems' 2620 or data source's 2622 personal computer, cellular phone, smartphone, laptop, tablet computer, e-reader device, audio player, or another device capable of connecting to the network 2618. Such a device may have a browser module that is implemented as a module that uses text, graphics, audio, video, and other media to present data and to allow interaction with data via the network 2618.

The output module may be implemented as a combination of an all-points addressable display such as a cathode ray tube (CRT), a liquid crystal display (LCD), a plasma display, or other types and/or combinations of displays. The output module may be implemented to communicate with interfaces 2612 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another implementation, a user may interact with the system more directly such as through a system terminal connected to the score generator without communications over the Internet, a WAN, or LAN, or similar network.

In some implementations, the system 2602 may comprise a physical or logical connection established between a remote microprocessor and a mainframe host computer for the express purpose of uploading, downloading, or viewing interactive data and databases on-line in real time. The remote microprocessor may be operated by an entity operating the computer system 2602, including the client server systems or the main server system, an/or may be operated by one or more of the data sources 2622 and/or one or more of the computing systems 2620. In some implementations, terminal emulation software may be used on the microprocessor for participating in the micro-mainframe link.

In some implementations, computing systems 2620 who are internal to an entity operating the computer system 2602 may access the module 2614 internally as an application or process run by the CPU 2606.

In some implementations, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name, and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the creator. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

The computing system 2602 may include one or more internal and/or external data sources (for example, data sources 2622). In some implementations, one or more of the data repositories and the data sources described above may be implemented using a relational database, such as DB2, Sybase, Oracle, CodeBase, and Microsoft® SQL Server as well as other types of databases such as a flat-file database, an entity relationship database, and object-oriented database, and/or a record-based database.

The computer system 2602 may also access one or more databases 2622. The databases 2622 may be stored in a database or data repository. The computer system 2602 may access the one or more databases 2622 through a network 2618 or may directly access the database or data repository through I/O devices and interfaces 2612. The data repository storing the one or more databases 2622 may reside within the computer system 2602.

### Conclusion

In the foregoing specification, the systems and processes have been described with reference to specific implementation thereof. It will, however, be evident that various modifications and changes may be made thereto without departing from the broader spirit and scope of the implementations disclosed herein. The specification and drawings are, accordingly, to be regarded in an illustrative rather than restrictive sense.

Indeed, although the systems and processes have been disclosed in the context of certain implementations and examples, it will be understood by those skilled in the art that the various implementations of the systems and processes extend beyond the specifically disclosed implementations to other alternative implementations and/or uses of the systems and processes and obvious modifications and equivalents thereof. In addition, while several variations of the implementations of the systems and processes have been shown and described in detail, other modifications, which are within the scope of this disclosure, will be readily apparent to those of skill in the art based upon this disclosure. It is also contemplated that various combinations or sub-combinations of the specific features and aspects of the implementations may be made and still fall within the scope of the disclosure. It should be understood that various features and aspects of the disclosed implementations can be combined with, or substituted for, one another in order to form varying modes of the implementations of the disclosed systems and processes. Any methods disclosed herein need not be performed in the order recited. Thus, it is intended that the scope of the systems and processes herein disclosed should not be limited by the particular implementations described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every implementation.

It will also be appreciated that conditional language used herein, such as, among others, “can,” “could,” “might,” “may,” “for example,” and the like, unless specifically stated otherwise, or otherwise understood within the context as used, is generally intended to convey that certain implementations include, while other implementations do not include, certain features, elements and/or operations. Thus, such conditional language is not generally intended to imply that features, elements and/or operations are in any way required for one or more implementations or that one or more implementations necessarily include logic for deciding, with or without author input or prompting, whether these features, elements and/or operations are included or are to be performed in any particular implementation. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other implementations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the implementations are not to be limited to the particular forms or methods disclosed, but, to the contrary, the implementations are to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or implementation can be used in all other implementations or implementations set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (for example, as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (for example, as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain implementations require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the implementations shown herein but are to be accorded the widest scope consistent with this disclosure, the principles and the novel features disclosed herein.

What is claimed is:

1. A computer-implemented method for lineage tracking of assets, the computer-implemented method comprising:
accessing a request for lineage tracking, the request comprising information relating to a first asset;
determining one or more first metadata items of the first asset;
determining, using a vector embedding model, a first vector embedding for the first asset;
comparing the one or more first metadata items of the first asset to a plurality of second metadata items associated with a plurality of second assets;
comparing the first vector embedding to a plurality of second vector embeddings associated with the plurality of second assets; and
identifying, based on (1) comparing the one or more first metadata items of the first asset to the plurality of second metadata items associated with the plurality of second assets and (2) comparing the first vector embedding to the plurality of second vector embeddings associated with the plurality of second assets, one or more potentially related assets,
wherein the one or more potentially related assets are selected from the plurality of second assets,
wherein the one or more potentially related assets are identified by at least one of:
determining that the one or more first metadata items have more than a first threshold similarity with second metadata items of the plurality of second metadata items, or
determining that the first vector embedding has more than a second threshold similarity with second vector vectors of the plurality of second vector embeddings.

2. The computer-implemented method of claim 1, wherein the information relating to the first asset comprises the first asset.

3. The computer-implemented method of claim 1, wherein the first asset is an asset that was generated using at least one generative artificial intelligence model, wherein the one or more potentially related assets comprise at least one asset that was potentially used to generate the first asset.

4. The computer-implemented method of claim 1, wherein the first asset is a potential source asset, and wherein the one or more potentially related assets comprise at least one asset that was potentially generated using a generative artificial intelligence model, wherein the at least one asset was potentially generated based at least in part on the first asset.

5. The computer-implemented method of claim 1, wherein comparing the first vector embedding for the first asset to the plurality of second vector embeddings comprises, for each second vector embedding of the plurality of second vector embeddings, determining a vector similarity comprising at least one of: L1 distance, L2 distance, cosine similarity, or dot product similarity.

6. The computer-implemented method of claim 1, wherein the first asset comprises an image, wherein determining the first vector embedding comprises:
extracting a portion of the first asset using a first machine learning model, wherein the portion of the first asset comprises at least one of: a foreground, a background, or a subject; and
determining a vector embedding of the portion of the first asset.

7. The computer-implemented method of claim 1, wherein the first asset comprises an audio file, wherein determining the first vector embedding comprises:
generating an image comprising a spectrogram of a portion of the audio file; and
determining a vector embedding of the image.

8. The computer-implemented method of claim 1, wherein the first asset comprises a text file, wherein determining the first vector embedding comprises:
splitting the text file into a plurality of chunks; and
determining, for at least one chunk of the plurality of chunks, a vector embedding.

9. The computer-implemented method of claim 1, wherein the first asset comprises a video file, wherein determining the first vector embedding comprises:
extracting at least one frame from the video file; and
determining a vector embedding for the at least one frame.

10. The computer-implemented method of claim 1, further comprising:
determining a first perception hash for the first asset; and
comparing the first perception hash to a plurality of second perception hashes corresponding to the plurality of second assets,
wherein the one or more potentially related assets are further determining based at least in part on the comparing of the first perception hash to the plurality of second perception hashes.

11. A non-volatile, computer-readable medium having instructions stored thereon that, when executed by a computing system, cause the computing system to:
access a request for lineage tracking of a first asset, the request comprising information relating to the first asset;
determine one or more first metadata items of the first asset;
determine, using a vector embedding model, a first vector embedding for the first asset;
compare the one or more first metadata items of the first asset to a plurality of second metadata items associated with a plurality of second assets;
compare the first vector embedding to a plurality of second vector embeddings associated with the plurality of second assets; and
identify, based on (1) comparing the one or more first metadata items of the first asset to the plurality of second metadata items associated with the plurality of second assets and (2) comparing the first vector embedding to the plurality of second vector embeddings associated with the plurality of second assets, one or more potentially related assets,
wherein the one or more potentially related assets are selected from the plurality of second assets,
wherein the one or more potentially related assets are identified by at least one of:
determining that the one or more first metadata items have more than a first threshold similarity with second metadata items of the plurality of second metadata items; or
determining that the first vector embedding has more than a second threshold similarity with second vector vectors of the plurality of second vector embeddings.

12. The non-volatile, computer-readable medium of claim 11, wherein the information relating to the first asset comprises the first asset.

13. The non-volatile, computer-readable medium of claim 11, wherein the first asset is an asset that was generated using at least one generative artificial intelligence model, wherein the one or more potentially related assets comprise at least one asset that was potentially used to generate the first asset.

14. The non-volatile, computer-readable medium of claim 11, wherein the first asset is a potential source asset, and wherein the one or more potentially related assets comprise at least one asset that was potentially generated using a generative artificial intelligence model, wherein the at least one asset was potentially generated based at least in part on the first asset.

15. The non-volatile, computer-readable medium of claim 11, wherein comparing the first vector embedding for the first asset to the plurality of second vector embeddings comprises, for each second vector embedding of the plurality of second vector embeddings, determining a vector similarity comprising at least one of: L1 distance, L2 distance, cosine similarity, or dot product similarity.

16. The non-volatile, computer-readable medium of claim 11, wherein the first asset comprises an image, wherein determining the first vector embedding comprises:
extracting a portion of the first asset using a first machine learning model, wherein the portion of the first asset comprises at least one of: a foreground, a background, or a subject; and
determining a vector embedding of the portion of the first asset.

17. The non-volatile, computer-readable medium of claim 11, wherein the first asset comprises an audio file, wherein determining the first vector embedding comprises:
generating an image comprising a spectrogram of a portion of the audio file; and
determining a vector embedding of the image.

18. The non-volatile, computer-readable medium of claim 11, wherein the first asset comprises a text file, wherein determining the first vector embedding comprises:
splitting the text file into a plurality of chunks; and
determining, for at least one chunk of the plurality of chunks, a vector embedding.

19. The non-volatile, computer-readable medium of claim 11, wherein the first asset comprises a video file, wherein determining the first vector embedding comprises:
extracting at least one frame from the video file; and
determining a vector embedding for the at least one frame.

20. The non-volatile, computer-readable medium of claim 11, further comprising:
determining a first perception hash for the first asset; and
comparing the first perception hash to a plurality of second perception hashes corresponding to the plurality of second assets,
wherein the one or more potentially related assets are further determining based at least in part on the comparing of the first perception hash to the plurality of second perception hashes.
